(19) United States
(12) Patent Application Publication
(10) Pub. No.: US 2012/0050432 A1
(43) Pub. Date: Mar. 1, 2012

(54) INK JET RECORDING MEDIUM AND IMAGE FORMING METHOD

(75) Inventor: Hiroshi KAWAKAMI, Kanagawa (JP)

(73) Assignee: FUJIFILM CORPORATION, Tokyo (JP)

(21) Appl. No.: 13/191,446

(22) Filed: Jul. 27, 2011

(30) Foreign Application Priority Data
Aug. 31, 2010 (JP) 2010-194120

(51) Int. Cl. B41J 2/01; B41J 3/407

(52) U.S. Cl. 347/102; 347/106

(57) ABSTRACT

The present invention provides an inkjet recording medium including: a substrate; a solvent absorbing layer, provided on the substrate, including white pigment other than silica particles, a binder, and a cationic or nonionic cellulose compound; and an ink receiving layer, provided on the solvent absorbing layer, including inorganic fine particles and a water-soluble resin.

### CROSS-REFERENCE TO RELATED APPLICATION

This application claims priority under 35 USC 119 from Japanese Patent Application No. 2010-194120 filed on Aug. 31, 2010, the disclosure of which is incorporated by reference herein.

### BACKGROUND OF THE INVENTION

1. Field of Invention

The present invention relates to an ink jet recording medium and an image forming method.

2. Description of the Related Art

With recent rapid advances in the information technology industry, various information-processing systems have been developed, and recording methods and apparatuses which are suitable for the information-processing systems have been developed and put into practical use.

As a result of various researches in both sides of an apparatus such as a printer and an image recording medium, it has become possible to obtain photograph-like high-quality images in recent years. An inkjet recording medium is generally required to have various properties, and among these, rapid absorption of applied ink is important in view of achieving high resolution of recorded images (suppression of ink bleeding) and high-speed recording (quick-drying properties). In addition, glossiness and surface smoothness are requested in consideration of application of photo-gloss paper, which provides so-called photograph-like images.

On the other hand, development of techniques which enable to produce a recording medium at a lower cost, which provide a certain level of image quality, has been also requested.

In relation to the above, image recording media having a laminate structure in which two or more layers are provided on a substrate has been proposed for a long time.

Examples thereof include an inkjet recording medium having, on a water-impermeable substrate such as a polyethylene resin-coated paper, a first ink receiving layer (lower layer) containing kaolin and another ink receiving layer (upper layer) containing gas phase silica. Such inkjet recording medium is said to exhibit excellent ink absorbing properties and image densities (for example, see Japanese Patent Application Laid-Open (JP-A) No. 2010-058346, 2010-058347, and 2010-076221). Examples thereof further include a recording material which having an ink receiving layer provided on an undercoat layer containing secondary kaolin, carboxymethyl cellulose and the like (for example, see JP-A No. 2003-251914).

Further, it has been known that a water-soluble cationic polymer, which is specifically diethylammonium chloride hydroxyethyl cellulose, can be used as a mordant used in an ink image receiving layer (for example, see JP-A No. 2003-025714).

In the above-described conventional inkjet recording medium which is composed of a lower layer containing kaolin or the like and an upper layer gas phase silica or the like, the void ratio of the lower layer is lower than the void ratio of the upper layer that is porous. Accordingly, there is a problem such that when an ink is applied onto the upper layer and a solvent in the ink passes through the upper layer to reach the lower layer, the amount of ink (solvent) that the lower layer can absorb (namely, absorption capacity) is not sufficient.

Even if an inkjet recording medium has plural layers, sufficient solvent absorption properties may not be secured by simply incorporating diethylammonium chloride hydroxyethyl cellulose, which is known as a cationic polymer, into a layer which directly contacts an applied ink.

The present invention was made in consideration of the above circumstances and in order to address the above problems. An object of the present invention is to provide an inkjet recording medium exhibiting excellent ink absorbency (especially solvent absorbency) and an image forming method which provides excellent image quality with suppression of image blurring (bleeding).

### SUMMARY OF THE INVENTION

According to an aspect of the present invention, there is provided an inkjet recording medium comprising: a substrate; a solvent absorbing layer, provided on the substrate, comprising a white pigment other than silica particles, a binder, and a cationic or nonionic cellulose compound; and an ink receiving layer, provided on the solvent absorbing layer, comprising inorganic fine particles and a water-soluble resin.

According to another aspect of the present invention, there is provided an image forming method comprising: applying an ink onto the inkjet recording medium by ink jetting to form an image; and drying the formed image by heating.

### DETAILED DESCRIPTION OF THE INVENTION

Details of the inkjet recording medium and the image forming method according to the invention are described below.

Inkjet Recording Medium

The inkjet recording medium of the invention is composed of at least a substrate and, provided on the substrate in the following order, a solvent absorbing layer containing at least a white pigment other than silica particles, a binder, and a cationic or nonionic cellulose compound, and an ink receiving layer containing at least inorganic fine particles and a water-soluble resin.

The inkjet recording medium has a plural layer structure which include two or more layers including the solvent absorbing layer and the ink-receiving layer on the substrate. The solvent absorbing layer, which is provided between the ink receiving layer and the substrate, is formed using an appropriate amount of the cationic or nonionic cellulose compound in addition to the binder and the white pigment which is different from silica particles as inorganic fine particles. By virtue of the above plural layer structure, absorbency of a solvent in an ink that is achieved by the solvent absorbing layer when the ink is applied onto the ink receiving layer and penetrates into the solvent absorbing layer disposed under the ink receiving layer, may be remarkably improved even when the solvent absorbing layer has a formulation which does not provide such porous structure as the ink receiving layer.

Solvent absorption of the solvent absorbing layer may be improved by incorporating therein an appropriate cellulose compound in addition to a binder even when the solvent absorbing layer has a formulation which hardly provides voids therein due to a white pigment such as kaolin or calcium carbonate, which is different from silica particles, as a main component thereof. As a result, ink absorbency of the inkjet recording medium as a whole may be enhanced. The “main component” herein means that a content of the white pigment in the solvent absorbing layer is 50% by mass or more with respect to the total solid content of the solvent absorbing layer.

Solvent Absorbing Layer

The inkjet recording medium has at least one solvent absorbing layer provided on a substrate. The solvent absorbing layer is provided between the substrate and an ink receiving layer described below and absorbs primarily a solvent in an ink. Specific examples of the solvent include water and a mixture solvent of water and an organic solvent. The solvent absorbing layer is composed of at least a white pigment (inorganic particles) other than silica particles, a binder and a cationic or nonionic cellulose compound. The solvent absorbing layer may further contain other components such as a dispersant or surfactant in accordance with necessity.

Inorganic Fine Particles

The solvent absorbing layer contains, as inorganic fine particles, at least one kind of white pigment other than silica particles. As the white pigment contained in the solvent absorbing layer, a whitish inorganic pigment may be preferably used. Particles which hardly form a porous structure may be used. In a preferable embodiment, the particles which hardly form a porous structure may be used as the inorganic fine particles from the viewpoints of enhancing an effect that is obtained by incorporation of the cellulose compound in the solvent absorbing layer and making a contribution to cost reduction.

Examples of the white pigment usable in the solvent absorbing layer include zinc oxide, aluminum oxide, aluminum hydroxide, aluminum silicate, calcium carbonate, magnesium oxide, magnesium carbonate, magnesium silicate, kaolin (including calcined kaolin), clay, satin white, zeolite, synthetic zeolite, sepiolite, smectite, synthetic smectite, diatomaceous earth, and hydrotalcite. Among these, metal oxides, hydroxides, sulphates, and carbonates which are white pigments other than silica particles may be preferable in view of the effect of the invention, specifically from the viewpoint of using particles that hardly form a porous structure. Among these, kaolin and calcium carbonate may be preferable.

Examples of the calcium carbonate include CALLITE SA (trade name, manufactured by Shiraishi Kogyo Kaisha, Ltd.).

The kaolin is not specifically limited, and for example, in addition to natural kaolin clay (hereinafter, also referred to simply as “kaolin clay”), processed kaolin clay such as calcined kaolin and delaminated kaolin can be used.

The calcined kaolin represents amorphous aluminum silicate anhydride in which natural kaolin clay has been heated at high temperature in a furnace and water of crystallization has been removed. Examples of the calcined kaolin include ALPHATEX, OPCITEX (trade names, manufactured by Imerys Minerals Japan K.K.), KAOCAL (trade made, manufactured by SHIRAISHI CALCIUM KAISHA, LTD.), ANSILEX 93 (trade name, manufactured by Engelhard Corporation), and GLOMAXLL (trade name, manufactured by TAKEHARA KAGAKU KOGYO CO., LTD.).

The delaminated kaolinite is formed by applying mechanical force to natural kaolin clay (kaolinite) to carry out interlayer detachment pulverization, and has a flat plate shape. The kaolinite represents a silicate having 1:1 layer of two octahedrals. Although the 1:1 layer ideally represents a chemical composition of Al₂Si₂O₅.(OH)₄, a few Fe³⁺ is included in place of Al as octahedral cations in many cases. Therefore, kaolinite generally represents a plate shape, but when physical force is applied externally, detachment occurs between layers and flatter kaolinite is obtained. Since this pulverization method is generally referred to as delamination pulverization for the purpose of layer detachment, the kaolinite obtained by this operation is referred to as delaminated kaolin, delamination clay, delaminated clay, or the like. In the delaminated kaolin used for the invention, engineered delaminated kaolin having a particle diameter in the specific range is also included.

Further, the aspect ratio of the kaolin is generally about from 15 to 20. With respect to a particular kind of kaolin that is referred to as engineered delaminated kaolin having a fine and uniform particle diameter, the aspect ratio of the engineered delaminated kaoin may be larger than 50.

Examples of the delaminated kaolin include ASTRA PLATE (trade name, manufactured by Imerys Minerals Japan K.K.), KAOWHITE S, KAOWHITE, and KAOWHITE C (trade names, manufactured by SHIRAISHI CALCIUM KAISHA, LTD.), POLYPLATE P, POLYPLATE P01, and POLYPLATE HMT (trade names, manufactured by J.M.Huber Corporation), NU CLAY (trade name, manufactured by Engelhard Corporation), and KAOLUX-HS (trade name, manufactured by SHIRAISHI CALCIUM KAISHA, LTD.), ASTRA-PLUS (trade name, manufactured by Imerys Minerals Japan K.K.), engineered delamination kaolin such as CONTOUR 1500 (trade name, manufactured by Imerys Minerals Japan K.K.), CONTOUR 2070 (trade name, manufactured by Imerys Minerals Japan K.K.), CONTOUR XTREME (trade name, manufactured by Imerys Minerals Japan K.K.), CAPIM DG (trade name, manufactured by Imerys Minerals Japan K.K.), CAPIM NP (trade name) and CAPIM CC (trade name, manufactured by Imerys Minerals Japan K.K.).

Examples of the kaolin clay include ASTRA-SHEEN, ASTRA-GLOSS, ASTRA-COTE, BETA-BRITE, ASTRA-GLAZE, PREMIER LX, PREMIER, and KCS (trade names, manufactured by Imerys Minerals Japan K.K.), KAOGLOSS 90, KAOBRITE 90, KAOGLOSS, KAOBRITE, and KAOFINE (trade names, manufactured by SHIRAISHI CALCIUM KAISHA, LTD.), Union clay RC-1 (trade name, manufactured by TAKEHARA KAGAKU KOGYO CO., LTD.), HUBER35, HUBER35B, HUBER80, HUBER80B, HUBER90, HUBER90B, HUBERHG90, HUBER TEK2001, POLYGLOSS90, and LITHOSPERSE 7005CS (trade names, manufactured by J.M.Huber corporation).

Among them, from the viewpoint of securing absorbency, the kaolin used for the invention is preferably calcined kaolin or kaolin clay.

In the case of using the kaolin, an average particle diameter of the kaolin contained in the first ink receiving layer is not specifically limited, but from the viewpoints of solvent absorbency, the average particle diameter is preferably from 0.3 μm to 15 μm, and more preferably from 1 μm to 10 μm.

As a pigment component, other pigments other than the kaolin may be used in combination with the kaolin in the solvent absorbing layer.

Examples of the other pigments include the above-described white pigment other than the kaolin, silica fine particles such as gas phase silica or wet-process silica described below, and colloidal silica.

An average particle diameter of the white pigment like kaolin may be preferably in a range of from 1 μm to 20 μm, more preferably in a range of from 2 μm to 15 μm, and further preferably in a range of from 3 μm to 10 μm. The “average particle diameter” herein means an average particle diameter of agglomerate particles in a case where the white pigment is an agglomerated pigment. When the average particle diameter is 1 μm or more, the increase of the solvent absorption rate may be more enhanced, and when the average particle diameter is 20 μm or less, the smoothness and glossiness of the recording medium may be further improved.

A content of the white pigment (inorganic fine particles) other than silica particles in the solvent absorbing layer may be preferably in a range of from 40% by mass to 95% by mass with respect to the total mass of the solvent absorbing layer. When the content of the inorganic fine particles is 40% by mass or more with respect to the total mass of the solvent absorbing layer, the solvent absorbency of the solvent absorbing layer may be maintained to be favorable, and when the content of the inorganic fine particles is 95% by mass or less, it may be an advantage in terms of a surface state of the coated layer.

In a case where the solvent absorbing layer contains silica fine particles, colloidal silica or the like together with the white pigment, the silica fine particles, colloidal silica or the like may be contained as long as the effect of the invention is not impaired and a total content of the white pigment and silica fine particles, colloidal silica or the like is within the above described content range of the inorganic fine particles.

Binder

The solvent absorbing layer contains at least one kind of a binder. The binder contained in the solvent absorbing layer may be either the same kind of a water-soluble resin as those contained in the ink receiving layer described below or a different kind of binder.

By inclusion of the binder, inorganic fine particles may be more favorably dispersed and film strength of the coated layer may be increased. In view of the above, it is preferable that the binder has a film forming property. Accordingly, it is preferable that the binder used for the invention does not include a cellulose compound having poor film forming property.

The binder may be may be used selecting from various resin materials such as water-soluble resins or latexes.

A water-soluble resin may be preferably used as a binder. Examples thereof include polyvinyl alcohol (including modified polyvinyl alcohol such as acetoacetyl-modified polyvinyl alcohol, carboxyl-modified polyvinyl alcohol, itaconic acid-modified polyvinyl alcohol, maleic acid-modified polyvinyl alcohol, silica-modified polyvinyl alcohol or amino group-modified polyvinyl alcohol), starch (including modified starch), gelatin, gum arabic, casein, styrene-anhydrous maleate copolymer hydrolysate, polyacrylamide and saponified vinyl acetate-polyacrylic acid copolymer. Further, examples of the binder include a latex-based binder of a synthetic polymer such as styrene-butadiene copolymer, vinyl acetate copolymer, acrylonitrile-butadiene copolymer, methyl acrylate-butadiene copolymer and polyvinylidene chloride.

Details of the polyvinyl alcohol are described in the section of the ink receiving layer described below.

The content of the binder in a solvent absorbing layer may be preferably in a range of from 5% by mass to 50% by mass, and more preferably in a range of from 7% by mass to 20% by mass, with respect to the total solid content of the solvent absorbing layer.

Content Ratio of Inorganic Fine Particles and Binder in Solvent Absorbing Layer

A content ratio [PB ratio (x/y)] of inorganic fine particles (x) to the binder (y) in the solvent absorbing layer is represented by a mass of the inorganic fine particles per one part by mass of the binder. The PB ratio may be preferably in a range of from 20/1 to 5/1 from the viewpoints of suppressing both film-strength reduction and cracking under the dry condition both of which are caused by excessively large PB ratio as well as suppressing reduction of solvent absorbency that is caused by excessively small PB ratio by which voids are likely occupied with a resin, and may be more preferably in a range of from 15/1 to 7/1 in view of further enhancing solvent absorbency.

Cellulose Compound

The solvent absorbing layer contains at least one kind of a cationic or nonionic cellulose compound. The inclusion of the cellulose compound at an appropriate content ratio in addition to the binder may further enhance solvent absorbency of the solvent absorbing layer which is located under the ink receiving layer.

Among cellulose compounds, the cellulose compound which is cationic or nonionic is specifically used in the present invention from the viewpoint of compatibility into a liquid used when the solvent absorbing layer is formed. A cellulose compound which is cationic (hereinafter, may be referred to as “a cationic cellulose compound”, “a cationized cellulose compound” or the like) may be more preferable in view of better compatibility.

The cationic cellulose compound is a cellulose compound which is cationized by introducing a cationic group such as an ammonium group or an amino group into cellulose in accordance with a normal method. Examples of the cationic cellulose compound include cationized cellulose compounds such as hydroxyethyl cellulose (HEC), methyl cellulose (MC), ethyl cellulose (EC), hydroxypropyl cellulose (HPC), and hydroxypropylmethyl cellulose. Commercially-available cationized cellulose compounds may be also used. Examples thereof include JELLNER QH-200 and JELLNER QH-300 (both trade names, manufactured by Daicel Chemical Industries, Ltd.), POIZ C-150L and POIZ C-60H (both trade names, hydroxyethyl cellulose hydroxypropyltrimethylammonium chloride ether, manufactured by Kao Corporation), and UCARE POLYMER JR-125, UCARE POLYMER JR-400, UCARE POLYMER JR-30M, UCARE POLYMER LR-400, and UCARE POLYMER LR-30M (all trade names, manufactured by Dow Chemical Company), each of which may be easily available and usable.

The cationic cellulose compound may be preferably used in the form of an aqueous solution containing about 3% by mass of the cationic cellulose compound in view of viscosity.

A degree of cationization of the cationic cellulose compound may be preferably 0.8% or more. When the degree of cationization is 0.8% or more, it may be an advantage in terms of a surface state of coated layer (especially glossiness). The degree of cationization of the cationic cellulose compound may be more preferably 1.5% or more. The upper limit of the degree of cationization may be desirably 4%.

The degree of cationization refers to a ratio (%) of cationic groups (for example, a nitrogen-containing group such as a quaternary amine) contained in a cationized cellulose molecule.

The degree of cationization may be determined by, for example, a colloid titration method. The colloid titration method may be specifically performed as follows. That is, 0.1 g of cationic cellulose is precisely weighed and dissolved in ion-exchanged water to obtain a 0.1% by mass-aqueous solution of the cationic cellulose. 10 g of the aqueous solution of the cationic cellulose is then precisely weighed, which is designated as “A” gram. After dilution of five times, three drops of toluidine blue is added thereto, and then titration is performed using 1/400 N aqueous solution of potassium poly(vinyl sulfate) (PVSK). The endpoint of the titration is indicated by a color change of toluidine blue from blue to (red) purple. An amount of the PVSK aqueous solution required for the titration is designated as “B” ml. On the other hand, an amount of the PVSK aqueous solution required for the same titration with respect to a blank sample, which is an aqueous solution having the same formulation as that of the cationic cellulose solution except that it is free of the cationic cellulose, is designated as “C” ml. The degree of cationization of the cationic cellulose compound may be measured using the following mathematical formula 1. In the formula 1, F means a factor of the 1/400 N PVSK.

(Normal concentration of PVSK)×(Atomic weight of Nitrogen)×[{(B−C)×F}/(Mass of Cationic cellulose)]×100 Formula 1:

Examples of the nonionic cellulose compound include hydroxyethyl cellulose (HEC), methyl cellulose (MC), ethyl cellulose, hydroxypropyl cellulose (HPC), and hydroxypropylmethyl cellulose. Commercially-available nonionic cellulose compounds may be also employable. Examples thereof include HPC-M, HPC-H, CELNY SSL, CELNY SL, and CELNY L (all trade names, manufactured by Nippon Soda Co., Ltd.), and SM-400 and SM-1500 (both trade names, manufactured by Shin-Etsu Chemical Co., Ltd.), each of which may be easily available and usable.

A content ratio of the cellulose compound to the binder contained in the solvent absorbing layer (cellulose compound/binder) may be preferably in a range of from 1/15 to 3/1. When this ratio is 1/15 or larger, the content of the cellulose compound with respect to the binder is not too small and thus the solvent absorbency may be further improved. When this ratio is 3/1 or smaller, the content of the cellulose compound with respect to the binder is not too large, and thus increase in viscosity of a coating liquid prepared for forming the solvent absorbing layer may be suppressed so that handling property and coating property of the coating liquid can be properly maintained.

Among the above range, the content ratio of cellulose compound/binder may be more preferably in a range of from 1/9 to 1/1, and still more preferably in a range of from 1/5 to 1/1.5.

The solvent absorbing layer may be formed by, for example, preparing a liquid for forming the solvent absorbing layer and applying the liquid on a substrate by coating or the like. A coating liquid may be generally adjusted to have a solid content of from 5% by mass to 50% by mass, and coated on a substrate in a manner such that a coating amount is from 3 g/m² to 30 g/m², and preferably from 5 g/m² to 20 g/m² in terms of dried amount applied onto the substrate. When the coated amount is 5 g/m² or more, the improvement of solvent absorbency may be enhanced and glossiness may become more favorable when an ink receiving layer is further provided thereon. When the applied amount is 20 g/m² or less, the film strength of the solvent absorbing layer may be increased and occurrence of a powder that has fallen off of the coated medium or a scratch may be suppressed.

The coating may be performed using any kind of known coating apparatuses such as a blade coater, an air knife coater, a roll coater, a brush coater, a champlex coater, a bar coater, a lip coater, a gravure coater, a curtain coater, a slot die coater, or a slide coater. The solvent absorbing layer may be obtained by drying the coated liquid. After drying the solvent absorbing layer, a smoothing treatment by supercalendering, brushing or the like may be further performed if needed.

There is no particular limitation to a thickness of the solvent absorbing layer. For example, the thickness may be preferably in a range of from 1 μm to 50 μm, and more preferably in a range of from 2 μm to 30 μm, in view of the solvent absorbency. The thickness of the solvent absorbing layer may be measured by cutting the solvent absorbing layer with a razor or a microtome and observing a cut surface (a cross section) of the solvent absorbing layer using an optical microscope.

Ink Receiving Layer

The inkjet recording medium includes at least one ink receiving layer provided on the solvent absorbing layer. The ink receiving layer serves as an outermost layer to receive an externally applied ink, and fixes a colorant thereon to perform image formation. The ink receiving layer is formed by using at least inorganic fine particles and a water-soluble resin, and may be formed by further using other components if necessary.

Inorganic Fine Particles

The ink receiving layer contains at least one kind of inorganic fine particles. Examples of the inorganic fine particles which can be contained in the ink receiving layer include silica particles, colloidal silica, alumina fine particles, boehmite, pseudo-boehmite, titanium dioxide, barium sulfate, calcium silicate, zeolite, kaolinite, halloysite, mica, talc, calcium carbonate, magnesium carbonate, and calcium sulfate. Of these, silica particles, alumina fine particles, and pseudo-boehmite may be preferable, and silica particles may be more preferable, and gas phase silica may be further preferable among the silica particles, from the viewpoint of printed image density, ink absorbency, and suppression of image blurring.

Silica particles have the following advantages. That is, since silica particles have an especially high specific surface area, the efficiency of ink absorbency and retention is high. Further, because of a low refractive index of silica particles, if the silica particles are dispersed in the ink receiving layer so that the silica particles have an adequate fine particle diameter, transparency may be imparted to an ink receiving layer containing the silica particles, and further high color density and good coloring property may be obtained. The advantages of the ink receiving layer being of transparency are significant from the viewpoints of obtaining high color density and good coloring property and glossiness, in the case of applications to a recording medium such as a photo-glossy paper as well as in the case of applications requiring transparency, such as OHP.

In general, silica particles are classified roughly into wet-method particles and dry-method (gas phase method) particles depending on the production method thereof. In a mainstream method of the wet method, generally, a silicate salt is decomposed with an acid to produce active silica, and the active silica is polymerized to a suitable extent to cause aggregation-precipitation to obtain hydrous silica. The silica particles obtained by the wet method may be referred to as “wet method silica”. On the other hand, a mainstream method of the gas phase method is classified roughly into the flame hydrolysis process and the arc method. In the flame hydrolysis process, generally, a silicon halide is hydrolyzed in a vapor phase at high temperature to form anhydrous silica. In the arc method, generally, quartz sand is heated and reduced with coke and vaporized in an electric furnace by applying arc discharge, followed by air oxidation, thereby forming anhydrous silica. The “gas phase silica” herein refers to anhydrous silica particles produced by the gas phase method.

Since there is a difference between the gas phase silica and the hydrous silica in the density of silanol groups present on the surface of silica, the presence of voids, or the like, the gas phase silica has different properties from the hydrous silica. The gas phase silica is suitable for forming a three-dimensional structure with a high void ratio (porosity). The reason for this is not clear, but is supposed as follows: the density of silanol groups present on the surfaces of hydrous silica fine particle is as much as 5 groups to 8 groups/nm²), whereby silica particles are easy to aggregate densely; in contrast, the density of silanol groups present on the surface of gas phase silica fine particle is as low as 2 groups to 3 groups/nm², whereby loose flocculation is formed, resulting in a three-dimensional structure with a high void ratio.

The gas phase silica contained in the ink receiving layer is preferably gas phase silica having from 2 groups/nm² to 3 groups/nm² in terms of the density of silanol groups present on the surface of silica. There is no particular limitation to an average particle diameter of the gas phase silica contained in the ink receiving layer. In embodiments, this average particle diameter may be preferably 10 nm or less from the viewpoints of enhancing printed image density and ink absorbency.

The specific surface area of the gas phase silica, which is measured by a BET method, may be preferably 200 m²/g or more, more preferably 250 m²/g or more, and particularly preferably 380 m²/g or more. When the specific surface area is 200 m²/g or more, the ink receiving layer may have high transparency and high printed image density.

The BET method used for the invention is one of methods for measuring a surface area of a powder by a vapor-phase adsorption method. The method is a method of measuring a total surface area of 1 g of a sample, namely a specific surface area, from an adsorption isotherm. Generally, nitrogen gas is most often used as the adsorption gas, and the adsorbed amount of gas is most often measured from the pressure or volume variations of gas to be adsorbed. The most famous equation representing an isotherm of multimolecular adsorption is the equation suggested by Brunauer, Emmett, and Teller, which is called a BET equation, and widely used for determining the surface area. A surface area can be obtained by measuring an adsorption amount based on the BET equation and multiplying the adsorption amount by an area occupied by one molecule adsorbed on the surface.

The ink receiving layer may further contain, as a pigment component, inorganic fine particles other than gas phase silica in combination with the gas phase silica.

The content of the inorganic fine particles (especially the gas phase silica) in the ink receiving layer may be preferably in a range of from 40% by mass to 90% by mass, and more preferably in a range of from 50% by mass to 80% by mass, with respect to the total solid content of the ink receiving layer from the viewpoints of further enhancing a printed image density and ink absorbency.

When the gas phase silica is used, the mass ratio of the gas phase silica in the ink receiving layer may be preferably in a range of from 60% by mass to 100% by mass, and more preferably in a range of from 80% by mass to 100% by mass, with respect to the total mass of the inorganic fine particles in the ink receiving layer from the viewpoints of further enhancing a printed image density and ink absorbency.

Water-Soluble Resin

The ink receiving layer contains at least one water-soluble resin.

When the ink receiving layer contains the water-soluble resin, inorganic particles are more preferably dispersed therein, whereby layer strength can be further improved.

The kind of the water-soluble resin in the ink receiving layer may be the same or different from that of the solvent receiving layer.

Examples of the water-soluble resin which can be used in the ink receiving layer include polyvinyl alcohol (including modified polyvinyl alcohol such as acetoacetyl-modified polyvinyl alcohol, carboxyl-modified polyvinyl alcohol, itaconic acid-modified polyvinyl alcohol, maleic acid-modified polyvinyl alcohol, silica-modified polyvinyl alcohol or amino group-modified polyvinyl alcohol), methyl cellulose, carboxymethyl cellulose, starch (including modified starch), gelatin, gum arabic, casein, styrene-anhydrous maleate copolymer hydrolysate, polyacrylamide and saponified vinyl acetate-polyacrylic acid copolymer.

Polyvinyl Alcohol

The polyvinyl alcohol includes polyvinyl alcohol obtained by saponifying lower alcohol solution of polyvinyl acetate, and derivative of the polyvinyl alcohol, and further includes a saponified copolymer of vinyl acetate and a monomer capable of copolymerization with vinyl acetate. Examples of the monomer capable of copolymerization with vinyl acetate include unsaturated carboxylic acid such as (anhydrous) maleic acid, fumaric acid, crotonic acid, itaconic acid, or (meth)acrylic acid, and esters thereof; α-olefin such as ethylene or propylene; olefin sulfonic acid such as (meth)allyl sulfonic acid, ethylene sulfonic acid, or maleate sulfonic acid; alkali salt of olefin sulfonic acid such as sodium (meth)allyl sulfonate, sodium ethylene sulfonate, sodium (meth)acrylate sulfonate, sodium (monoalkyl maleate) sulfonate, or sodium alkyl maleate disulfonate; and amide group-containing monomer such as N-methylol acrylamide, or alkali salt of acrylamide alkylsulfonate, and derivatives of N-vinylpyrrolidone.

Among these polyvinyl alcohols, a polyvinyl alcohol having a saponification degree of from 92 mol % to 98 mol % (hereinafter, referred to as “a polyvinyl alcohol with a high saponification degree”) is especially preferred.

When the saponification degree of the polyvinyl alcohol is 92 mol % or more, favorable halftone color hue can be obtained, and increase in viscosity of the coating liquid can be effectively suppressed, and excellent coating stability can be obtained.

When the saponification degree of the polyvinyl alcohol is 98 mol % or less, ink absorbency can be further improved.

The saponification degree of the polyvinyl alcohol is more preferably from 93 mol % to 97 mol %.

The polymerization degree of the polyvinyl alcohol with a high saponification degree is preferably from 1,500 to 3,600, and more preferably from 2,000 to 3,500. When the polymerization degree is 1,500 or more, cracks in the ink receiving layer can be more efficiently suppressed. When the polymerization degree is 3,600 or less, increase in viscosity of the coating liquid can be more efficiently suppressed.

In the invention, as a water-soluble resin, a polyvinyl alcohol with a high saponification degree may be used in combination with a water-soluble resin other than the polyvinyl alcohol with a high saponification degree. Examples of the water-soluble resin that can be used in combination with the polyvinyl alcohol with a high saponification degree include: a resin having a hydroxyl group as a hydrophilic structure unit, such as polyvinyl alcohol (PVA) having a saponification degree other than the range described above, cation-modified polyvinyl alcohol, anion-modified polyvinyl alcohol, silanol-modified polyvinyl alcohol, polyvinyl acetal, chitins, chitosans, or starch; a resin having a hydrophilic ether bond, such as polypropylene oxide (PPO), polyethylene glycol (PEG), or polyvinyl ether (PVE); and a resin having a hydrophilic amide group or a hydrophilic amide bond, such as polyacrylamide (PAAM), or polyvinyl pyrrolidone (PVP). Further, examples of the water-soluble resin include a resin having a carboxyl group as a dissociative group such as a polyacrylic acid salt, a maleic acid resin, an alginic acid salt, or gelatins.

In a case where the polyvinyl alcohol with a high saponification degree and the water-soluble resin described above are used in combination, the ratio of the polyvinyl alcohol with a high saponification degree with respect to the total amount of the polyvinyl alcohol with a high saponification degree and the water-soluble resin is preferably from 1% by mass to 30% by mass, more preferably from 3% by mass to 20% by mass, and particularly preferably from 6% by mass to 12% by mass.

The content of a polyvinyl alcohol, especially the polyvinyl alcohol with a high saponification degree in an ink receiving layer is preferably from 9% by mass to 40% by mass, and more preferably from 12% by mass to 33% by mass with respect to the total solid mass of the ink receiving layer, from the viewpoints of preventing a decrease in film strength or an occurrence of cracking while drying, which are induced by an excessively low content of the polyvinyl alcohol, and from the viewpoints of preventing reduction in ink-absorbency that results from decrease in porosity due to an increased tendency for pores to be clogged by the resins, which is induced by excessively high content of the polyvinyl alcohol.

The polyvinyl alcohol has hydroxyl groups in the structural unit thereof, and the hydroxyl groups and the silanol groups on the surface of the silica fine particles form hydrogen bonding, whereby a three-dimensional network structure having secondary particles of the silica fine particles as chain units is easily formed. It is presumed that a porous-structured ink receiving layer having high porosity can be formed by the formation of such a three-dimensional network structure.

In the ink jet recording medium, the porous ink receiving layer obtained in the above manner can absorb ink rapidly by capillary action and form excellent true-circularly dots without ink bleeding.

Content Ratio of Inorganic Particles to Water-Soluble Resin in Ink Receiving Layer

The content ratio of the inorganic particles (x) to the water-soluble resin (y) in the ink receiving layer [PB ratio (x/y), the mass of the pigment with respect to 1 part by mass of the water-soluble resin] also has a large influence on the layer structure of the ink receiving layer. In other words, the larger the PB ratio is, the larger the porosity, pore volume and surface area (per unit mass) are. Specifically, the PB ratio (x/y) of the whole ink receiving layer is preferably from 1.5/1 to 10/1 from the viewpoints of preventing a decrease in layer strength and cracks while drying, which are induced by an excessively high PB ratios and from the viewpoints of preventing reduction in ink absorbency that results from decrease in porosity due to an increased tendency for pores to be clogged by the resins, which is induced by excessively low PB ratios, and more preferably from 1.5/1 to 8/1, from the viewpoints of effectively preventing a decrease in film strength and cracks while drying.

When passing through the transport system of an inkjet printer, the inkjet recording medium is subjected to stress in some cases; therefore, the ink receiving layer is required to have sufficient film strength. The sufficient strength of the ink receiving layer is also required from the standpoint of avoiding occurrences such as cracking and detachment of the ink receiving layer when the recording medium is processed by cutting it into sheets. From the above standpoint, the PB ratio (x/y) of the whole ink receiving layer is preferably 10/1 or less.

For example, when a coating liquid prepared by completely dispersing gas phase silica having an average primary particle diameter of 20 nm or less and the polyvinyl alcohol with a high saponification degree at the PB ratio (x/y) of from 1.5/1 to 10/1 in an aqueous solution is coated on a substrate and the resultant coating layer is dried, a three-dimensional network structure is formed which has secondary particles of the gas phase silica fine particles as network chains, whereby a light-transmitting porous film having an average pore diameter of 30 nm or less, a porosity of from 50% to 80%, a specific pore volume of 0.5 ml/g or more, and a specific surface area of 100 m²/g or more can be easily formed.

Boron Compound

The ink receiving layer in the invention contains at least one kind of boron compound.

Further, it is preferred that the boron compound is used as a cross-linking agent in the ink receiving layer. In other words, the ink receiving layer in the invention is preferably a porous layer which is cured through a cross-linking reaction of a water-soluble resin (for example, polyvinyl alcohol) by the boron compound.

Examples of the boron compound include borax, boric acid, borates (such as orthoborate, InBO₃, ScBO₃, YBO₃, LaBO₃, Mg₃(BO₃)₂, CO₃(BO₃)₂), diborates (such as Mg₂B₂O₅, CO₂B₂O₅), metaborates (such as LiBO₂, Ca(BO₂)₂, NaBO₂, KBO₂), tetraborates (such as Na₂B₄O₇.10H₂O), pentaborates (such as KB₅O₈.4H₂O, CsB₅O₅), and hexaborates (such as Ca₂B₆O₁₁.7H₂O). Of these, from the viewpoint of rapid cross-linking reaction, borax, boric acid, and borates are preferred, and boric acid or borate is particularly preferred and it is most preferable to use boric acid or borate in combination with polyvinyl alcohol.

The boron compound is preferably included in the all ink receiving layers at an amount of from 0.05 parts by mass to 0.50 parts by mass, and more preferably from 0.08 parts by mass to 0.45 parts by mass, with respect to 1.0 part by mass of the polyvinyl alcohol. When the content of the boron compound is in the above range, the polyvinyl alcohol is effectively cross-linked thereby preventing cracks or the like.

In a case where gelatin is used as the water soluble resin, the following compounds other than the boron compound may be used as a cross-linking agent (hereinafter, referred to as “other cross-linking agents”).

Examples of the other cross-linking agents include: aldehyde compounds such as formaldehyde, glyoxal and gultaraldehyde; ketone compounds such as diacetyl and cyclopentanedione; active halogen compounds such as bis(2-chloroethylurea)-2-hydroxy-4,6-dichloro-1,3,5-triazine and sodium salts of 2,4-dichloro-6-s-triazine; active vinyl compounds such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds such as dimethylolurea and methyloldimethylhydantoin; melamine resins such as methylolmelamine and alkylated methylolmelamine; epoxy resins; isocyanate compounds such as 1,6-hexamethylene diisocyanate; the aziridine compounds described in U.S. Pat. Nos. 3,017,280 and 2,983,611; the carboxylmide compounds described in U.S. Pat. No. 3,100,704; epoxy compounds such as glycerol triglycidyl ether; ethyleneimino compounds such as 1,6-hexamethylene-N,N′-bisethyleneurea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate and chromium acetate; polyamine compounds such as tetraethylenepentamine; hydrazide compounds such as adipic acid dihydrazide; and low-molecular compounds or polymers each having at least two oxazoline groups. The other cross-linking agents may be used alone or in combination of two or more kinds thereof.

Nitrogen-Containing Organic Cationic Polymer

It is preferred that the ink receiving layer in the invention contains at least one nitrogen-containing organic cationic polymer from the viewpoint of suppressing bleeding of a recorded image and the viewpoint of dispersing silica.

The nitrogen-containing organic cationic polymer in the invention is not specifically limited, but a polymer having a primary amino group, a secondary amino group, a tertiary amino group or a quaternary ammonium salt is preferred.

Examples of the nitrogen-containing organic cationic polymer include: a nitrogen-containing organic cationic polymer which is a homopolymer of the monomer (nitrogen-containing organic cation monomer) having any of from primary to tertiary amino groups or a salt thereof or a quaternary ammonium salt group; a nitrogen-containing organic cationic polymer obtained as a copolymer or condensate of the nitrogen-containing organic cation monomer and other monomers; a conjugated diene copolymer such as styrene-butadiene copolymer, or methylmethacrylate-butadiene copolymer; an acrylic polymer such as a polymer or copolymer of acrylic acid ester and methacrylic acid ester, or a polymer or copolymer of acrylic acid and methacrylic acid; a styrene-acryl polymer such as styrene-acrylic acid ester copolymer, or styrene-methacrylic acid ester copolymer; a vinyl polymer such as ethylene vinyl acetate copolymer; a nitrogen-containing organic cationic polymer obtained by cationically modifying a urethane polymer having a urethane bond by using a compound having a cationic group.

Examples of the nitrogen-containing organic cation monomer include trimethyl-p-vinyl benzyl ammonium chloride, trimethyl-m-vinyl benzyl ammonium chloride, triethyl-p-vinyl benzyl ammonium chloride, triethyl-m-vinyl benzyl ammonium chloride, N,N-dimethyl-N-ethyl-N-p-vinyl benzyl ammonium chloride, N,N-diethyl-N-methyl-N-p-vinyl benzyl ammonium chloride, N,N-dimethyl-N-n-propyl-N-p-vinyl benzyl ammonium chloride, N,N-dimethyl-N-n-octyl-N-p-vinyl benzyl ammonium chloride, N,N-dimethyl-N-benzyl-N-p-vinyl benzyl ammonium chloride, N,N-diethyl-N-benzyl-N-p-vinyl benzyl ammonium chloride, N,N-dimethyl-N-(4-methyl)benzyl-N-p-vinyl benzyl ammonium chloride, N,N-dimethyl-N-phenyl-N-p-vinyl benzyl ammonium chloride; trimethyl-p-vinyl benzyl ammonium bromide, trimethyl-m-vinyl benzyl ammonium bromide, trimethyl-p-vinyl benzyl ammonium sulfonate, trimethyl-m-vinyl benzyl ammonium sulfonate, trimethyl-p-vinyl benzyl ammonium acetate, trimethyl-m-vinyl benzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate; a quaternarized compound obtained by reacting N,N-dimethyl aminoethyl(meth)acrylate, N,N-diethyl aminoethyl(meth)acrylate, N,N-dimethyl aminopropyl(meth)acrylate, N,N-diethylaminopropyl(meth)acrylate, N,N-dimethyl aminoethyl(meth)acrylamide, N,N-diethyl aminoethyl(meth)acrylamide, N,N-dimethyl aminopropyl(meth)acrylamide, or N,N-diethylaminopropyl(meth)acrylamide, with methyl chloride, ethyl chloride, methylbromide, ethyl bromide, methyl iodide or ethyl iodide, or a sulfonic acid salt, an alkylsulfonic acid salt, an acetic acid salt or an alkylcarboxylic acid salt, each of which is obtained by anion substitution of the above quaternarized compound.

Examples of the specific compound include monomethyl diallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride; N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloylamino)propyl ammonium chloride, trimethyl-2-(methacryloyloxy)ethylammonium bromide, trimethyl-3-(acryloylamino)propyl ammonium bromide, trimethyl-2-(methacryloyloxy)ethylammonium sulfonate, and trimethyl-3-(acryloylamino)propyl ammonium acetate. Examples of the copolymerizable monomer include N-vinylimidazole, and N-vinyl-2-methylimidazole. A polymerization unit such as N-vinylacetamide, N-vinylformamide, or the like may be used for polymerization, and the resultant polymer may be hydrolyzed to generate a vinyl amine unit. This unit may be converted to a salt thereof. These units may be used in the invention.

Examples of the other monomers capable of copolymerization (or condensation-polymerization) with the nitrogen-containing organic cationic monomer include a monomer which does not contain a basic or cationic portion such as any of from primary to tertiary amino groups or a salt thereof or a quaternary ammonium salt group, and which does not interact or has substantially low interaction with a dye in an inkjet ink. Specific examples thereof include alkyl(meth)acrylic ester; cycloalkyl(meth)acrylic ester such as cylohexyl(meth)acrylate; aryl(meth)acrylic ester such as phenyl(meth)acrylate; aralkyl ester such as benzyl(meth)acrylate; aromatic vinyl monomers such as styrene, vinyltoluene, or α-methylstyrene; vinyl esters such as vinyl acetate, vinyl propionate, or vinyl versatate; allyl esters such as allyl acetate; a halogen-containing monomer such as vinylidene chloride, or vinyl chloride; vinyl cyanide such as (meth)acrylonitrile; and olefins such as ethylene or propylene.

For example, the alkyl(meth)arylic ester is preferably alkyl(meth)acrylic esters having an alkyl moiety of from 1 to 18 carbon atoms. Specific examples thereof include methyl (meth)acrylate, ethyl (meth)acrylate, propyl(meth)acrylate, isopropyl(meth)acrylate, n-butyl (meth)acrylate, isobutyl(meth)acrylate, t-butyl (meth)acrylate, hexyl(meth)acrylate, octyl(meth)acrylate, 2-ethylhexyl(meth)acrylate, lauryl(meth)acrylate, and stearyl (meth)acrylate. Among them, methyl acrylate, ethyl acrylate, methyl methacrylate, ethyl methacrylate, and hydroxyethyl methacrylate are preferred. The other monomers may be used alone or in combination of two or more kinds.

Further, examples of a monomer used for forming the urethane polymer include a polyvalent isocyanate compound having two or more isocyanate groups (such as 2,4-tolylene diisocyanate, 2,6-tolylene diisocyanate, m-phenylene diisocyanate, 4,4′-diphenyl methane diisocyanate, hexamethylene diisocyanate, octamethylene diisocyanate, 1,4-cyclohexylene diisocyanate, isophorone diisocyanate, 1,3-bis(methylisocyanate)-cylcohexane, 1,5-diisocyanate-2-methylpentane, hydrogenated xylylene diisocyanate, or hydrogenated 4,4′-diphenyl methane diisocyanate) and a compound capable of forming a urethane bond by reacting with an isocyanate group (for example, a polyol compound such as glycerin, 1,6-hexanediol, triethanolamine, polypropylene glycol, polyethylene glycol, bisphenol A, hydroquinone; succinic acid, adipic acid, azelaic acid, sebacinic acid, dodecanedicarboxylic acid, maleic anhydride, fumaric acid, 1,3-cyclopentane dicarboxylic acid, 1,4-cyclohexane dicarboxylic acid, terephthalic acid, isophthalic acid, phthalic acid, 1,4-naphthalene dicarboxylic acid, 2,5-naphthalene dicarboxylic acid, 2,6-naphthalene dicarboxylic acid, naphthalene acid, biphenyl carboxylic acid, sorbitol, saccharose, aconitic acid, trimellitic acid, hemimellitic acid, phosphoric acid, diethylenetriamine, triisopropanolamine, pyrogallol, dihydroxybenzoic acid, hydroxyphthalic acid, 1,2,3-propanetrithiol; diamines such as ethylene diamine, propylene diamine, hexamethylene diamine, phenylene diamine, tolylene diamine, diphenyl diamine, diaminodiphenyl methane, diaminocyclohexylmethane, piperazine, isophorone diamine; or hydrazines).

Further, examples of the compound capable of introducing a cationic group into a copolymer or condensate that does not have a cationic group include alkyl halides and methyl sulfate.

Among the nitrogen-containing organic cationic polymers, from the viewpoint of suppressing bleeding, cationic polyurethanes and cationic polyacrylates described in JP-A No. 2004-167784 are preferred, and cationic polyurethanes are more preferred. Examples of the commercially available product of the cationic polyurethane include “SUPER FLEX 650”, “SUPER FLEX 650-5”, “F-8564D”, “F-8570D” (all trade names, manufactured by Dai-Ichi Kogyo Seiyaku Co., Ltd.), and “NEOFIX IJ-150” (trade name, manufactured by Nicca Chemical Co., Ltd.).

From the viewpoints of pigment dispersion, polydiallyl dimethyl ammonium chloride, and a polymethacryloyloxyethyl-β-hydroxyethyl dimethyl ammonium chloride derivative are preferable, and polydiallyl dimethyl ammonium chloride is more preferable.

Examples of the commercially available product thereof includes “SHALLOL DC 902P” (trade name, manufactured by Dai-ichi Kogyo Seiyaku Co., Ltd).

Further, as the nitrogen-containing organic cationic polymer, cation-modified self-emulsifying polymers described in paragraphs from 0018 to 0046 of JP-A No. 2007-223119 may be used.

The nitrogen-containing organic cationic polymer may be used in any form of a water-soluble polymer, water dispersible latex particles, or an aqueous emulsion.

Examples of the aqueous emulsion include conjugation a diene-based copolymer emulsion; an acryl-based polymer emulsion; a styrene-acryl-based polymer emulsion; a vinyl-based polymer emulsion; an urethane-based emulsion cationized by using a compound having a cationic group, an emulsion the surface of which is cationized with a cationic surfactant, and an emulsion produced by polymerization under the presence of cationic polyvinyl alcohol, in which the polyvinyl alcohol is disposed on the surface of the emulsion. Among these cationic emulsions, cationic polyurethane emulsion which contains urethane emulsion as a main component is preferred.

The nitrogen-containing organic cationic polymer is preferably cationic polyurethane and more preferably cationic polyurethane emulsion, from the viewpoints of suppression of bleeding.

Water-Soluble Aluminum Compound

It is preferred that the ink receiving layer in the invention contains a water-soluble aluminum compound.

Inclusion of the water-soluble aluminum compound may enhance water-proof of formed image and resistance of bleeding over time.

Examples of the water-soluble aluminum compound include a known inorganic salt such as aluminum chloride or a hydrate thereof, aluminum sulfate or a hydrate thereof, or ammonium alum. Further, the examples thereof include a basic polyaluminum hydroxide compound which is an inorganic aluminum-containing cationic polymer. Among them, the basic polyaluminum hydroxide compound is preferred.

The basic polyaluminum hydroxide compound refers to a water-soluble polyalumium hydroxide represented by the following Formulae 1, 2 or 3 as a main component, which stably includes a basic polymeric multinuclear condensation ion such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ(5<m<80,1<n<5) Formula 1

[Al(OH)₃]ₙAlCl₃(1<n<2) Formula 2

Alₙ(OH)ₘCl₍₃ₙ₋ₘ₎(0<m<3n,5<m<8) Formula 3

These compounds are available from Taki Chemical Co., Ltd. as a water treatment agent under the trade name of POLYALUMINUM CHLORIDE (PAC), from Asada Chemical INDUSTRY Co. LTD. under the trade name of POLYALUMINUM HYDROXIDE (PAHO), from RIKENGREEN CO., LTD. under the trade name of PURACHEM WT, from TAIMEI CHEMICALS Co., Ltd. under the trade name of ALFINE 83, or from other manufacturers as products for similar applications, and products of various grade are available. In the invention, these commercially available products can be used without any processing. However, when the pH of the commercially available product is unsuitably low, the pH may be adjusted suitably.

The content of the water-soluble aluminum compound in an ink receiving layer is preferably from 0.1% by mass to 20% by mass, more preferably from 1% by mass to 8% by mass, and most preferably from 2% by mass to 4% by mass, with respect to the total solid content of the ink receiving layer, from the viewpoints of improving glossiness, water resistance, gas resistance, and light resistance.

Zirconium Compound

It is preferred that the ink receiving layer in the invention contains a zirconium compound.

When the zirconium compound is used, water resistance may be increased.

The zirconium compound used in the invention is not specifically limited, and various zirconium compounds can be used. The examples thereof include zirconyl acetate, zirconium chloride, zirconium oxychloride, zirconium hydroxychloride, zirconium nitrate, basic zirconium carbonate, zirconium hydroxide, ammonium zirconium carbonate, potassium zirconium carbonate, zirconium sulfate, and zirconium fluoride. Zirconyl acetate is particularly preferred.

The content of the zirconium compound in the ink receiving layer is preferably from 0.05% by mass to 5.0% by mass, more preferably from 0.1% by mass to 3.0% by mass, and most preferably from 0.5% by mass to 2.0% by mass with respect to the total solid content of the ink receiving layer, from the viewpoints of improving water resistance without deteriorating ink absorbency.

In the invention, other water-soluble multivalent metal compounds other than the water-soluble aluminum compound and the zirconium compound described above may be additionally used. Examples of the other water-soluble multivalent metal compounds include a water-soluble salt of metal selected from calcium, barium, manganese, copper, cobalt, nickel, iron, zinc, chromium, magnesium, tungsten and molybdenum.

Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amide sulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate 9-hydrate, sodium phosphorus tungstate, sodium tungsten citrate, 12 tungsten phosphate n-hydrate, 12 tungstosilicate 26-hydrate, molybdenum chloride, and 12 molybdenum phosphate n-hydrate.

Other Components

The ink receiving layer in the present invention may contain the following components if necessity.

That is, the ink receiving layer may include an anti-fading agent such as a variety of ultraviolet absorbents, antioxidants, and singlet oxygen quenchers, thereby suppressing degradation of ink colorants.

Examples of the ultraviolet absorbent include cinnamic acid derivatives, benzophenone derivatives, and benzotriazolylphenol derivatives. Specific examples thereof include butyl α-cyano-phenyl cinnamate, o-benzo triazolylphenol, o-benzo triazole-p-chlorophenol, o-benzo trizole-2,4-di-t-butylphenol, and o-benzo triazole-2,4-di-t-octylphenol. A hindered phenol compound also can be used as the ultraviolet absorbent, and specifically, a phenol derivative in which at least one of 2-position or 6-position is substituted with a branched alkyl group is preferred.

Further, benzotriazole ultraviolet absorbent, salicylic acid ultraviolet absorbent, cyanoacrylate ultraviolet absorbent, and oxalic acid anilide ultraviolet absorbent may be used. Examples thereof are described, for example, in JP-A No. 47-10537, JP-A No. 58-111942, JP-A No. 58-212844, JP-A No. 59-19945, JP-A No. 59-46646, JP-A No. 59-109055, JP-A No. 63-53544, Japanese Patent Application Examined Publication (JP-B) No. 36-10466, JP-B No. 42-26187, JP-B No. 48-30492, JP-B No. 48-31255, JP-B No. 48-41572, JP-B No. 48-54965, JP-B No. 50-10726, U.S. Pat. No. 2,719,086, U.S. Pat. No. 3,707,375, U.S. Pat. No. 3,754,919, and USP No. 4,220,711.

A fluorescent brightener can also be used as the ultraviolet absorbent, and examples of the fluorescent brightener include a coumalic fluorescent brightener. Examples thereof are described, for example, in JP-B No. 45-4699 and JP-B No. 54-5324.

Examples of the antioxidant include an antioxidant such as those described in European Patent (EP) No. 223739, EP No. 309401, EP No. 309402, EP No. 310551, EP No. 310552, EP No. 459416, German Patent (GP) No. 3435443, JP-A No. 54-48535, JP-A No. 60-107384, JP-A No. 60-107383, JP-A No. 60-125470, JP-A No. 60-125471, JP-A No. 60-125472, JP-A No. 60-287485, JP-A No. 60-287486, JP-A No. 60-287487, JP-A No. 60-287488, JP-A No. 61-160287, JP-A No. 61-185483, JP-A No. 61-211079, JP-A No. 62-146678, JP-A No. 62-146680, JP-A No. 62-146679, JP-A No. 62-282885, JP-A No. 62-262047, JP-A No. 63-051174, JP-A No. 63-89877, JP-A No. 63-88380, JP-A No. 66-88381, JP-A No. 63-113536; JP-A No. 63-163351, JP-A No. 63-203372, JP-A No. 63-224989, JP-A No. 63-251282, JP-A No. 63-267594, JP-A No. 63-182484, JP-A No. 1-239282, JP-A No. 2-262654, JP-A No. 2-71262, JP-A No. 3-121449, JP-A No. 4-291685, JP-A No. 4-291684, JP-A No. 5-61166, JP-A No. 5-119449, JP-A No. 5-188687, JP-A No. 5-188686, JP-A No. 5-110490, JP-A No. 5-1108437, JP-A No. 5-170361, JP-B No. 48-43295, JP-B No. 48-33212, U.S. Pat. No. 4,814,262, and U.S. Pat. No. 4,980,275.

Specific examples of the antioxidant include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

The anti-fading agent may be used alone, or in combination of two or more thereof. The anti-fading agent may be water-solubilized, dispersed, or emulsified, or may be contained in a micro capsule. The amount of the anti-fading agent to be added is preferably from 0.01% by mass to 10% by mass of the preparation liquid for forming the ink receiving layer.

In the present invention, the ink receiving layer preferably contains a high-boiling-point organic solvent for prevention of curling. The high-boiling-point organic solvent is preferably water-soluble, and examples of the water-soluble high-boiling-point organic solvent include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (weight-average molecular weight of 400 or less). Among these, diethylene glycol monobutyl ether (DEGMBE) is preferred.

The content of the high-boiling-point organic solvent in the preparation liquid for the ink receiving layer is preferably from 0.05% by mass to 1% by mass, and particularly preferably from 0.1% by mass to 0.6% by mass.

The ink receiving layer may contain, for example, various inorganic salts and acid or alkali as a pH adjuster, thereby increasing dispersibility of the inorganic fine particles.

The ink receiving layer may also contain metal oxide fine particles having electroconductivity, thereby suppressing electrification of the surface of the ink receiving layer due to the friction or peeling. The ink receiving layer may also contain various matt agents, thereby reducing friction at the surface of the ink receiving layer.

The thickness of the ink receiving layer of the invention is not specifically limited but, for example, is preferably from 3 μm to 30 μm and more preferably from 5 μm to 20 μm, from the viewpoints of ink absorbency and glossiness.

The thickness of the ink receiving layer is determined by vertically cutting a sample with a razor, a microtome, or the like, and measuring the thickness in terms of cut section (cross-section) of the ink receiving layer with an optical microscope.

Additional Layer

The inkjet recording medium of the invention may have, on a substrate, an additional layer other than the solvent receiving layer and the ink receiving layer. For example, the inkjet recording medium optionally has an uppermost layer (such as a colloidal silica layer, or the like), an intermediate layer, or a functional layer to which a function such as a cushion property or an antistatic property is imparted.

Substrate

The inkjet recording medium of the invention includes a substrate. As for the substrate, a water permeable substrate or a water impermeable substrate may be used.

From the viewpoint of suppressing deformation such as curling caused by image recording, the water-impermeable substrate is preferable.

In the invention, the term “water impermeable” refers to a property in which no water is absorbed or a water absorption amount is 0.3 g/m² or less.

As for the water impermeable substrate, it is possible to use a transparent substrate made of a transparent material such as plastic or an opaque substrate made of an opaque material such as paper. In order to utilize the transparency of the ink receiving layer, it is preferable to use a transparent substrate or a highly-glossy opaque substrate. Further, a read-only optical disk such as a CD-ROM or a DVD-ROM, a write-once optical disk such as a CD-R or a DVD-R, or a rewritable optical disk may be used as a substrate, and the ink receiving layer may be applied onto the label surface side thereof.

The material of the transparent substrate is preferably transparent and resistant to radiation heat when the inkjet recording medium is used on an OHP or a back light display. Examples of the material include polyesters such as polyethylene terephthalate (PET), polysulfone, polyphenylene oxide, polyimide, polycarbonate, and polyamide. Among them, polyesters are preferable, and polyethylene terephthalate is particularly preferable.

The thickness of the transparent substrate has no particular limits, but it is preferably from 50 μm to 200 μm in view of easiness in handling.

Examples of the opaque substrate include: high-gloss paper substrates such as art paper, coated paper, cast-coated paper, and baryta paper commonly used as silver salt photographic substrates; high-gloss films opacified by incorporating a white pigment or the like into plastic films such as polyesters (for example, polyethylene terephthalate (PET)), cellulose esters (for example, nitrocellulose, cellulose acetate, and cellulose acetate butyrate), polysulfone, polyphenylene oxide, polyimide, polycarbonate, or polyamide (wherein the surface of the high-gloss films may be subjected to a calender treatment); and substrates having a polyolefin coating layer containing, or not containing, a white pigment and formed on the surface of the various paper substrates, the transparent substrates, or the high-gloss films containing a white pigment or the like.

Foamed polyester films containing a white pigment (for example, a foamed PET having voids formed by stretching a PET that contains polyolefin fine particles) are also favorable. Polyolefin resin-coated papers having a structure formed by coating the surface of base paper with a polyolefin resin, such as resin-coated papers commonly used as photographic papers for silver salt photographs are also preferable.

Although the thickness of the opaque substrate is not particularly limited, it is preferably in a range of from 50 μm to 300 μm from the viewpoint of easiness in handling.

The surface of the substrate may be subjected to corona discharge treatment, glow discharge treatment, flame treatment, ultraviolet ray irradiation treatment or the like for improvement in wetting properties and adhesive properties.

Next, base paper used in a paper substrate such as a resin coated paper (polyolefin resin-coated paper) is described.

The base paper is made of wood pulp as a main raw material. When making the base paper, a synthetic pulp or a synthetic fiber may be optionally used in addition to the wood pulp. The synthetic pulp may be made of, for example, polypropylene, and the synthetic fiber may be, for example, a nylon fiber or a polyester fiber. As the wood pulp, any of LBKP, LBSP, NBKP, NBSP, LDP, NDP, LUKP or NUKP may be used. It is preferable to increase the total amount of LBKP, NBSP, LBSP, NDP and LDP, which have high contents of short fibers. However, the proportion of LBSP and/or LDP is preferably from 10% by mass to 70% by mass.

The pulp is preferably a chemical pulp (such as sulfate salt pulp or sulfite pulp), which has a low impurity content. A pulp of which whiteness is improved by bleaching is also useful.

To the base paper, it is also possible to add, as needed, a sizing agent such as a higher fatty acid or an alkylketene dimer, a white pigment such as calcium carbonate, talc or titanium oxide, a paper-strength enhancing additive such as starch, polyacrylamide or polyvinyl alcohol, a fluorescent brightener, a moisturizing agent such as polyethylene glycol, a dispersant, a softener such as quaternary ammonium, or the like.

The freeness, according to CSF (Canadian Standard Freeness), of the pulp used for paper-making is preferably from 200 mL to 500 mL. In regard to the fiber length after beating, the total sum of the percent by mass of the pulp remaining on a 24-mesh screen and the percent by mass of the pulp remaining on a 42-mesh screen according to JIS P-8207 (which is incorporated herein by reference) is preferably from 30% to 70% by mass. Further, the percent by mass of the pulp remaining on a 4-mesh screen is preferably 20% by mass or less.

The basis weight of base paper is preferably from 30 g/m² to 250 g/m², particularly preferably from 50 g/m² to 200 g/m². The thickness of the base paper is preferably from 40 μm to 250 μm. High smoothness may be imparted to the base paper by subjecting the base paper to a calender treatment during or after papermaking. The base paper density is generally from 0.7 g/m³ to 1.2 g/m³ (according to JIS P-8118, which is incorporated herein by reference). Furthermore, the stiffness of the base paper is preferably from 20 g to 200 g under the conditions defined by JIS P-8143, which is incorporated herein by reference.

The base paper surface may be coated with a surface sizing agent, which may be selected from the above-described sizing agent that may be incorporated into the interior of the base paper.

The pH of the base paper is preferably from 5 to 9 as measured according to the hydrothermal extraction method defined by JIS P-8113, which is incorporated herein by reference.

The polyolefin (preferably polyethylene) for coating the front and rear surfaces of the base paper mainly includes a low-density polyethylene (LDPE) and/or a high-density polyethylene (HDPE), and optionally includes a small amount of other polymers such as LLDPE or polypropylene.

In particular, a polyolefin layer (preferably a polyethylene layer) at a side on which the ink receiving layer is to be formed preferably includes at least one of rutile-titanium oxide or anatase-titanium oxide, a fluorescent brightener, and ultramarine, which are commonly used in photographic papers, whereby opacity, whiteness and hue are improved. The content of titanium oxide is preferably in a range of from about 3% by mass to about 20% by mass, and more preferably in a range of from 4% by mass to 13% by mass, with respect to polyethylene. The thickness of each of polyethylene layer on the front side and the polyethylene layer on the rear side is not particularly limited, but it is preferably in a range of from 10 μm to 50 μm. In addition, an undercoat layer may be formed on the polyethylene layer for imparting adhesion thereof to an ink receiving layer. The material of the undercoat layer preferably includes aqueous polyester, gelatin, and PVA. The thickness of the undercoat layer is preferably in a range of from 0.01 μm to 5 μm.

The polyolefin resin-coated paper (preferably, a polyethylene resin-coated paper) may be glossy paper, or paper having a matte or silky surface that is similar to that of common photographic printing paper and that has been formed by performing surface-finishing treatment when a base paper is coated thereon with polyethylene by melt-extrusion.

The substrate may have a back coating layer. Examples of components that can be added to the back coating layer include a white pigment, an aqueous binder, and one or more other components.

Examples of the white pigment that may be contained in the back coating layer include a white inorganic pigment such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate, or magnesium hydroxide; and an organic pigment such as a styrene-containing plastic pigment, an acrylic plastic pigment, polyethylene, microcapsule, urea resin, or melamine resin.

Examples of the aqueous binder that may be used in the back coating layer include a water-soluble polymer such as styrene/maleic acid salt copolymer, styrene/acrylic acid salt copolymer, polyvinyl alcohol, silanol-modified polyvinyl alcohol, starch, cationized starch, casein, gelatin, carboxymethylcellulose, hydroxyethyl cellulose, or polyvinyl pyrrolidone; and water-dispersible polymer such as styrene butadiene latex, or acrylic emulsion.

Examples of the one or more other components that may be contained in the back coating layer include a defoamer, an anti-foaming agent, a dye, a fluorescent brightener, a preservative, and a water-resistant additive.

Method of Producing Inkjet Recording Medium

There is no particular limitation to a method for producing the inkjet recording medium. In embodiments, the inkjet recording medium may be favorably produced by a method including: sequentially or simultaneously coating a coating liquid for forming a solvent absorbing layer containing a white pigment (inorganic fine particles) other than silica particles, a binder and a cationic or nonionic cellulose compound; and a coating liquid for forming an ink receiving layer containing inorganic fine particles and a water-soluble resin on a water impermeable substrate, so that the coating liquid for forming the solvent absorbing layer (hereinafter, also referred to as a first coating liquid) and the coating liquid for forming the ink receiving layer (hereinafter, also referred to as a second coating liquid) are laminated in this order from the water impermeable substrate side; and drying the coating liquids to provide the solvent absorbing layer and the ink receiving layer, thereby forming a multilayered structure. Hereinafter, the above process is referred to as a coating process.

In embodiments, the method for producing the inkjet recording medium may further include other processes if necessary.

In a case where the ink receiving layer has a two-layer structure, the ink receiving layer may be formed by, for example, coating a first coating liquid on a water impermeable substrate to form a solvent absorbing layer, and then coating two kinds of a second coating liquid onto the solvent absorbing layer to form an ink receiving layer having the two-layer structure.

The method of coating the first coating liquid and the second coating liquid (and an additional coating liquid if necessary) is not specifically limited so long as the first coating liquid and the second coating liquid are displaced in this order from the water-impermeable substrate.

For example, the coating method may be a sequential coating method of separately coating layer by layer (for example, a blade coater, an air knife coater, a roll coater, a bar coater, Gravure coater, a reverse coater, or the like), or may be a simultaneously multilayer-coating method in which plural coating liquids are simultaneously coated without interposing a drying process between coatings (for example, slide bead coater or slide curtain coater, or the like). Further, for example, the coating method may be “Wet-On-Wet method” (hereinafter, “WOW method”) described in paragraph from 0016 to 0037 of JP-A No. 2005-14593.

Among them, from the viewpoints that properties required in each layer are effectively obtained and production efficiency is excellent, a simultaneously multilayer-coating method is preferably used. That is, in simultaneously multilayer-coating, when each of the layers is superposed in a wet state, a component contained in each of the layers, for example, the upper layer (for example, an ink receiving layer) is hardly penetrated into the lower layer (for example, a solvent absorbing layer), whereby the component composition is well maintained in each of the layers after drying.

The coating amount of the first coating liquid for forming a solvent absorbing layer in terms of a solid content is preferably from 3 g/m² to 30 g/m² and more preferably from 5 g/m² to 20 g/m².

The coating amount of the second coating liquid for forming an ink receiving layer in terms of a solid content is preferably from 3 g/m² to 30 g/m² and more preferably from 5 g/m² to 20 g/m².

In the invention, the first coating liquid can be prepared, for example, as described below.

Kaolin and a dispersant are added to water (for example, kaolin in water is from 10% by mass to 20% by mass), and the resultant mixture is dispersed using a high speed rotating wet colloid mill (for example, “CLAIR MIX”, trade name, manufactured by M technique Co., Ltd) or a liquid-liquid collision dispersing machine (ULTIMAIZER, trade name, manufactured by Sugino Corporation). Into the dispersed mixture, aqueous polyvinyl alcohol (PVA) solution (for example, prepared in a manner such that a mass of PVA is about ⅓ of the mass of kaolin described above) and a cellulose compound are added, and further, if needed, a nitrogen-containing organic cationic polymer, an aqueous aluminum compound and a boron compound are added, and then dispersion is performed, thereby preparing the first coating liquid.

The water-soluble aluminum compound and the boron compound may be added by in-line mixing immediately before coating.

The above dispersion can be carried out using the liquid-liquid collision dispersing machine (ULTIMAIZER, trade name, manufactured by Sugino Corporation).

Regarding a preparation of an aqueous-dispersion including the kaolin and the dispersant, aqueous kaolin dispersion liquid prepared in advance may be added to an aqueous dispersant solution. Alternatively, the aqueous dispersant solution may be added to the aqueous kaolin dispersion liquid, or the kaolin and the dispersant may be simultaneously mixed. A kaolin powder in place of the aqueous kaolin dispersion may be added to the aqueous dispersant solution.

In the preparation, the dispersant may be a cationic polymer. Examples of the cationic polymer include the mordant described in JP-A No. 2006-321176, paragraphs [0138] to [0148]. Alternatively, the use of a silane coupling agent as the dispersant is also preferable.

The addition amount of the dispersant with respect to the inorganic fine particles is preferably from 0.1% by mass to 10% by mass, and more preferably 0.5% by mass to 5% by mass.

Preferable examples of a solvent usable for preparing a first coating liquid include water, an organic solvent, and a mixture solvent thereof. Examples of the organic solvent include alcohols such as methanol, ethanol, n-propanol, i-propanol and methoxy propanol, ketones such as acetone and methyl ethyl ketone, tetrahydrofuran, acetonitrile, ethyl acetate, and toluene.

A second coating liquid may be favorably prepared by, for example, the same manner as the above-described first coating liquid, except that kaolin is replaced by a gas phase silica. The second coating liquid is preferably prepared so as to be acidic. The pH thereof is preferably 5.0 or less, more preferably 4.5 or less, and even more preferably 4.0 or less. The pH can be adjusted by suitably selecting types or addition amount of nitrogen-containing cationic polymer. The pH may be adjusted by adding an organic or inorganic acid. When the pH of the second coating liquid is 5.0 or less, for example, cross-linking reaction of the binder by a cross-linking agent (particularly, boron compound) in the second coating liquid can be suppressed sufficiently.

It is preferable that the method of producing the inkjet recording medium of the present invention further includes applying, onto the following coating layer, a basic solution containing a basic compound either

(1) at the same time with the formation of the coating layer by coating at least the second coating liquid, or
(2) during drying of the coating layer formed by coating the second coating liquid, but before a decrease in drying rate of the coating layer.

The process of applying the basic solution in the method of producing the inkjet recording medium of the present invention further improves cross-linking and curing of the ink receiving layer.

The application of the basic solution “at the same time with the formation of the coating layer by coating at least the second coating liquid” is preferably carried out by simultaneously coating (multilayer-coating) the second coating liquid (and, optionally, one or more other coating liquids) and the basic solution in this order from the substrate side.

The application of the basic solution “at the same time with the formation of the coating layer by coating at least the second coating liquid” may be carried out by coating the first coating liquid, and then simultaneously coating the second coating liquid and the basic solution on the coated first coating liquid.

The application of the basic solution “during drying of the coating layer formed by coating the second coating liquid, but before the coating layer shows decreasing drying” is the method referred to as “Wet-On-Wet method” or “WOW method.” Details of the “Wet-On-Wet method” are described in, for example, paragraphs [0016] to [0037] of JP-A No. 2005-14593.

Herein, examples of the method of applying the basic solution during drying of the formed coating layer, but before the coating layer shows decreasing drying include (i) a method of further coating the basic solution on the thus-formed coating layer, (ii) a method of spraying the basic solution onto the thus-formed coating layer, or (iii) a method of immersing a substrate provided with the thus-formed coating layer in the basic solution.

Methods that may be used for coating the basic solution in the method (i) include known methods using a coater such as a curtain flow coater, an extrusion die coater, an air doctor coater, a blade coater, a rod coater, a knife coater, a squeeze coater, a reverse roll coater or a bar coater. Especially, it is preferable to employ a method of using a coater which does not directly contact an already-formed coating layer, such as an extrusion die coater, a curtain flow coater, or a bar coater.

The expression “before the coating layer shows decreasing drying” usually refers to a period of several minutes from immediately after coating of the coating liquids (and, if needed, one or more other coating liquids) and, in this period, the coating layer shows a phenomenon of “constant rate drying” whereby the solvent (dispersion medium) content in the coating layer is decreased in proportion to time. With respect to the period during which the “constant rate drying” is observed, Kagaku Kogaku Binran (Handbook of Chemical Technology), pages 707-712, MARUZEN Co., Ltd. (Oct. 25, 1980) may be referenced, for example.

Drying until the coating layer begins to show decreasing drying may be generally performed at 40° C. to 180° C. for 0.5 minutes to 10 minutes (preferably 0.5 minutes to 5 minutes). Although the drying time naturally varies with the coating amount, the range specified above is usually appropriate.

The pH of the basic solution is preferably 7.1 or more, more preferably 8.0 or more, and particularly preferably 9.0 or more. When the pH is 7.1 or more, cross-linking reaction of a binder or a water-soluble resin which may be contained in the first coating liquid and/or the second coating liquid can be promoted whereby bronzing or cracks of the ink receiving layer can be effectively suppressed.

Basic Compound

The basic solution contains at least one kind of basic compound.

Examples of the basic compound include ammonium salt of weak acid, alkali metal salt of weak acid (such as lithium carbonate, sodium carbonate, potassium carbonate, lithium acetate, sodium acetate, or potassium acetate), alkali earth metal salt of a weak acid (such as magnesium carbonate, barium carbonate, magnesium acetate, or barium acetate), hydroxylammonium, primary to tertiary amine (such as triethyl amine, tripropyl amine, tributylamine, trihexylamine, dibutylamine, or butylamine), primary to tertiary aniline (such as diethyl aniline, dibutyl aniline, ethyl aniline, or aniline), pyridine which may have a substituent group (such as 2-aminopyridine, 3-aminopyridine, 4-aminopyridine, or 4-(2-hydroxyethyl)-aminopyridine).

As for basic materials other than the basic compounds described above, other basic materials and/or salts thereof can be used in combination with the basic compound. Examples of the other basic materials include ammonia; a primary amine such as ethyl amine, polyallylamine; a secondary amine such as dimethyl amine; a tertiary amine such as N-ethyl-N-methylbutylamine; and hydroxide of alkali metal or alkali earth metal.

Among them, ammonium salt of weak acid is particularly preferred. The weak acid means an inorganic and organic acid having a pKa of 2 or more described in the Kagaku Binran Kisohen II (Chemical Handbook Basic Edition II), MARUZEN Co., Ltd. Examples of the ammonium salt of weak acid include ammonium carbonate, ammonium hydrogen carbonate, ammonium borate, ammonium acetate, and ammonium carbamate, however, the ammonium salt of weak acid is not limited thereto. Among them, ammonium carbonate, ammonium hydrogen carbonate, and ammonium carbamate are preferable and are effective from the viewpoints that there is no remains in the layer after drying, whereby ink bleeding can be reduced.

Two or more of the basic compounds may be used in combination.

The content of the basic compound (particularly ammonium salt of weak acid) in the basic solution is preferably from 0.5% by mass to 10% by mass and more preferably 1% by mass to 5% by mass, with respect to the total mass of basic solution (including solvent). When the content of the basic compound (particularly ammonium salt of weak acid) is in the range described above, a sufficient degree of cure is obtained and impair of a working environment due to the excessively high concentration of ammonia is prevented.

It is preferred that the basic solution contains at least one boron compound described above, from the viewpoints of further promoting both cross-linking and curing of the solvent absorbing layer and/or the ink receiving layer.

The content ratio of the boron compound in the basic solution is preferably from 0.20% by mass to 2.00% by mass, and more preferably from 0.30% by mass to 1.20% by mass.

Further, the basic solution may contain at least one metal compound.

Any metal compound that is stable under basic conditions may be used, without particular limitations, as the metal compound to be incorporated in the basic solution. Specifically, any of the water-soluble polyvalent metal salts described above, metal complex compounds, inorganic oligomers and inorganic polymers may be used. More specifically, zirconium compounds and the compounds listed as inorganic mordants in paragraphs [0100] and [0101] of JP-A No. 2005-14593 may be used. Examples of the metal complex compounds include the metal complexes described in Kagaku Sosetsu (Review of Chemistry), No. 32 (1981), edited by The Chemical Society of Japan, and the transition metal complexes containing transition metals such as ruthenium as described in Coordination Chemistry Review, vol. 84, pages 85-277 (1988), and JP-A No. 2-182701.

Among them, a zirconium compound and a zinc compound are preferred, and a zirconium compound is particularly preferred. Examples of the zirconium compound include ammonium zirconium carbonate, ammonium zirconium nitrate, potassium zirconium carbonate, ammonium zirconium citrate, zirconyl stearate, zirconyl octylate, zirconyl nitrate, zirconium oxychloride and zirconium chloride hydroxide. In particular, ammonium zirconium carbonate is preferred. Further, the basic solution may include two or more metal compounds (preferably including a zirconium compound) in combination.

The content of the metal compound (particularly, a zirconium compound) in the basic solution is preferably from 0.05% by mass to 5% by mass, and more preferably from 0.1% by mass to 2% by mass, with respect to the total mass (including the solvent) of the basic solution.

From the viewpoints of image density and ozone resistance, it is also preferable that the basic solution contains, as a metal compound, a magnesium salt such as those described above. The magnesium salt is particularly preferably magnesium chloride.

When the magnesium salt is contained, the amount of the magnesium salt contained in the basic solution is preferably from 0.1% by mass to 1% by mass with respect to a total mass of the basic solution.

The basic solution may contain the other cross-linking agents and one or more other mordant components, if necessary.

The basic solution may be prepared, for example, by adding a basic compound (for example, from 1% by mass to 5% by mass), and optionally, paratoluene sulfonic acid (for example, from 0.5% by mass to 3% by mass), to ion-exchange water, and then thoroughly stirring them. The “%” value for each ingredient represents % by mass of ingredient with respect to the total solid mass of the basic solution.

The solvent used for the preparation of the basic solution may be water, an organic solvent or a mixture thereof. Examples of organic solvents which may be used include alcohols such as methanol, ethanol, n-propanol, i-propanol and methoxypropanol; ketones such as acetone and methyl ethyl ketone; tetrahydrofuran; acetonitrile; ethyl acetate; and toluene.

The method of producing the inkjet recording medium of the invention may include cooling the coating layer formed in the coating process so that the temperature of the coating layers can be reduced to a temperature that is at least 5° C. lower than the lower of the temperature of the first coating liquid during the coating and the temperature of the second coating liquid during the coating (hereinafter, referred to as “cooling process”); and drying the cooled coating layer to form an ink receiving layer (hereinafter, referred to as “drying process”).

The cooling of the coating layer in the cooling process is preferably carried out by cooling the substrate on which the coating layer has been formed in a cooling zone maintained at a temperature of from 0° C. to 10° C. (preferably at a temperature of from 0° C. to 5° C.) for from 5 seconds to 30 seconds.

Herein, the temperature of the coating layer is determined by measuring the temperature of the layer surface.

In the present invention, the ink receiving layer that has been formed on the substrate may be calendered by, for example, passing the substrate having thereon the ink receiving layer through a nip between rolls under heat and pressure using a super calender, a gloss calender, or the like, whereby surface smoothness, glossiness, transparency, and film strength can be improved. However, the calender treatment sometimes becomes a factor of reduction in porosity (namely, reduction in ink absorbency). Therefore, it is important to perform the calender treatment under the conditions that cause less reduction in porosity.

In a case where the calender treatment is performed, the roll temperature is preferably from 30° C. to 150° C., and more preferably from 40° C. to 100° C.

The linear pressure applied between the rollers in the calender treatment is preferably from 50 kg/cm to 400 kg/cm, and more preferably from 100 kg/cm to 200 kg/cm.

Image Forming Method

The image forming method of the present invention utilizes the inkjet recording medium of the present invention as described above, and includes: at least an image formation process, which includes jetting an ink onto the inkjet recording medium according to an inkjet method to form an image; and a drying process, which includes drying the formed image by heating. In embodiments, the image forming method may further include other processes, if necessary.

Details of the inkjet recording medium are as described above.

Image Formation Process

Any inks which are generally used in inkjet recording may be used in the image forming method without any particular limitation. Examples of the inks include a water-based ink which contain a dye, water, and a water-soluble organic solvent and if necessary, may further contain other components like a surfactant.

Specific examples thereof include inks described in JP-A No. 2007-138124. Such inks may be also preferably used in the present invention.

An operation system of the inkjet recording method is not particularly limited and may be of any known system. Examples thereof include: a charge control system of ejecting an ink utilizing an electrostatic attraction force; a drop-on-demand system of utilizing a vibration pressure of a piezo element (pressure pulse system); an acoustic ink-jet system of converting electric signals into acoustic beams, irradiating them to an ink, and ejecting the ink utilizing a radiation pressure; and a thermal ink jet system known as BUBBLEJET®, that includes utilizing pressure from bubbles generated by heating of an ink.

Examples of the ink ejection mode used in the inkjet recording method include: a mode which includes jetting a number of ink droplets of low concentration, a so-called “photo-ink” each in a small volume; a mode which includes using plural inks of a substantially identical hue and of different concentrations to improve an image quality; and a mode which includes using a colorless and transparent ink.

The system of the inkjet head used in the inkjet recording method may be an on-demand system or a continuous system. Specific examples of the ejection system include an electric-mechanical conversion system (for example, single cavity type, double cavity type, vender type, piston type, share mode type, shared wall type, etc.), an electric-thermal conversion system (for example, thermal ink jet type, BUBBLEJET (registered trade mark) type, etc.), an electrostatic suction system (for example, electric field control type, slit jet type, etc.), and an electric discharge system (for example, spark jet type, etc.), and any of these ejection systems may be used in the invention.

There are no particular limitation to ink nozzles and the like that are used for recording by the inkjet recording method, and the ink nozzle may be properly selected depending on the purpose.

Examples of the inkjet head include: a shuttle system of performing recording using a serial head of a short length while scanning the head in the width direction of a recording medium; and a line system using a line head in which recording devices are arranged corresponding to all the regions of one side of a recording medium. In the line system, image recording can be performed throughout the surface of the recording medium by scanning the recording medium in the direction orthogonal to the arrangement direction of the recording devices. Moreover, only the recording medium moves in the line system. Thus, compared with the shuttle system, increase in a recording rate can be realized by the line system.

An amount of an ink droplet ejected from an ink jet head is preferably from 0.2 pl to 10 pl (picoliters), and more preferably from 0.4 pl to 5 pl.

The maximum total amount of an ink ejected from an ink jet head in image recording may be preferably in a range of from 10 ml/m² to 36 ml/m², and more preferably in a range of from 15 ml/m² to 30 ml/m².

Drying Process

The inkjet recording method of the invention includes a drying process which includes heating the inkjet recording medium which has an ink provided during the image formation process to remove at least a part of a solvent in the ink to dry up the recording medium.

There is no particular limitation to the drying process as long as it removes at least a part of organic solvent and water in the ink applied on the recording medium, and any conventionally-known methods may be used. Specific examples of the methods include non-contact drying methods such as: a method of heating by a heating element such as a nichrome wire heater; a method of supplying warmed air or hot air; or a method of heating by a halogen lamp, an infrared lamp or the like.

A heating temperature in the drying process may be appropriately selected and may be set in a range of, for example, from 25° C. to 70° C.

Since the image forming method of the invention uses the inkjet recording medium of the invention, the image forming method enables to form an image at a relatively higher speed due to the fast absorption of an ink spotted on the inkjet recording medium. Occurrence of image blurring may be further suppressed and high-quality images may be formed at much higher speed by further including the drying process in the image forming method whereby the inkjet recording medium having an ink spotted thereon is heated.

According to aspects of the present invention, for example, there are provided the following inkjet recording medium and image forming method.

<1> An inkjet recording medium including: a substrate; a solvent absorbing layer, provided on the substrate, including a white pigment other than silica particles, a binder, and a cationic or nonionic cellulose compound; and an ink receiving layer, provided on the solvent absorbing layer, including inorganic fine particles and a water-soluble resin.
<2> The inkjet recording medium according to the item <1>, wherein the content ratio of the cellulose compound to the binder (content ratio of the cellulose/the binder) in the solvent absorbing layer is from 1/15 to 3/1.
<3> The inkjet recording medium according to the item <1> or <2>, wherein the cationic or nonionic cellulose compound includes a cationized hydroxyethyl cellulose, a hydroxypropyl cellulose, or a methyl cellulose.
<4> The inkjet recording medium according to any one of the items <1> to <3>, wherein the binder in the solvent absorbing layer is a water-soluble resin or a latex resin.
<5> The inkjet recording medium according to any one of the items <1> to <4>, wherein at least one of the solvent absorbing layer or the ink receiving layer includes a nitrogen-containing organic cationic polymer.
<6> The inkjet recording medium according to any one of the items <1> to <5>, wherein the inorganic fine particles in the ink receiving layer include gas phase silica.
<7> The inkjet recording medium according to any one of the items <1> to <6>, wherein the water-soluble resin includes a polyvinyl alcohol.
<8> The inkjet recording medium according to any one of the items <1> to <7>, wherein a cationization degree of the cationic cellulose compound is 0.8% or more.
<9> The inkjet recording medium according to any one of the items <1> to <8>, wherein the white pigment includes at least one of kaolin or calcium carbonate.
<10> The inkjet recording medium according to any one of the items <1> to <9>, wherein the ink receiving layer comprises a boron compound.
<11> The inkjet recording medium according to any one of the items <1> to <10>, wherein the ink receiving layer includes a zirconium compound.
<12> The inkjet recording medium according to any one of the items <1> to <11>, wherein the ink receiving layer includes a water-soluble aluminum compound.
<13> The inkjet recording medium according to any one of the items <1> to <12>, wherein the substrate includes a water-impermeable substrate.
<14> An image forming method including:

applying an ink, by ink-jetting, onto the inkjet recording medium according to any one of items <1> to <13>, to form an image,

wherein a coating liquid of the solvent absorbing layer and a coating liquid of the ink receiving layer are provided in this order from the substrate side of the inkjet recording medium; and

drying the formed image by heating.

<15> The image forming method according to the item <14>, the method including:

applying, onto a coating layer, a basic solution containing a basic compound either (1) at the same time as forming the coating layer by coating at least the coating liquid for the ink receiving layer on the coating liquid of the solvent absorbing layer, or (2) during drying of the coating layer, but before a decrease in drying rate of the coating layer.

An inkjet recording medium exhibiting excellent ink absorbency (specifically, solvent absorbency) may be obtained according to the present invention. An image forming method which provides high-quality images with suppression of image blurring may be further obtained according to the present invention.

### EXAMPLES

Hereinafter, the invention is described in detail with reference to examples, but the invention is not limited to the following examples as long as the invention does not depart from the original gist thereof. Further, unless otherwise specified, “part(s)” and “%” are on the basis of mass.

### Example 1

### Manufacture of Water-Impermeable Substrate

50 parts of LBKP obtained from acacia and 50 parts of LBKP obtained from aspen were respectively beaten to a Canadian Standard Freeness of 300 ml by a disk refiner so as to prepare pulp slurry.

Next, to the pulp slurry obtained as described above, 1.3% of cationic starch (CAT0304L, manufactured by Nippon NSC), 0.15% of anionic polyacrylamide (POLYACRON ST-13, manufactured by Seiko Chemical Industries Co., Ltd.), 0.29% of alkylketene dimer (SIZEPINE K, manufactured by Arakawa Chemical Industries, Ltd.), 0.29% of epoxidized amide behenate and 0.32% of polyamide polyamine epichlorohydrin (ARAFIX 100, manufactured by Arakawa Chemical Industries, Ltd.) were added, and thereafter 0.12% of a defoamer was added thereto. The percentages above are percentages relative to the pulp.

The pulp slurry prepared as described above was used for paper making using a Fourdrinier paper machine. The felt face of the web was pressed against a drum dry cylinder via a dryer canvas interposed between them with the tensile strength of the dryer canvas set at 1.6 Kg/cm, thereby drying the web. Then, polyvinyl alcohol (KL-118, trade name, manufactured by Kuraray Co., Ltd.) was coated on both sides of a base paper in an amount of 1 g/m² by a size press, and then dried and calendered. The base paper was formed to have a basis weight of 157 g/m², and thus a base paper having a thickness of 157 μm (substrate paper) was obtained.

The wire face side (rear face) of the obtained substrate paper was subjected to corona discharge treatment. Thereafter, polyethylene prepared by blending high-density polyethylene/low-density polyethylene at a ratio of 80%/20% was coated on the wire face at a coating amount of 20 g/m² by melt extrusion at a temperature of 320° C. using a melt extruder, whereby a thermoplastic resin layer having a matte surface was formed (hereinafter, the surface having the above-described thermoplastic resin layer is referred to as “a rear face”). The thermoplastic resin layer on the rear face was subjected to a further corona discharge treatment, and thereafter, a dispersion liquid prepared by dispersing aluminum oxide (ALUMINA ZOL 100, trade name, manufactured by Nissan Chemical Industries, Ltd.) and silicon dioxide (NOWTEX O, trade name, manufactured by Nissan Chemical Industries, Ltd.) at a mass ratio of 1:2 as antistatic agents in water was applied at a dry mass of 0.2 g/m². Subsequently, the front face (the other surface of the rear face) was subjected to a corona discharge treatment, and then, polyethylene having a density of 0.93 g/m³ which included 10% by mass of titanium oxide was coated thereon in an amount of 24 g/m² by melt extrusion at a temperature of 320° C. using a melt extruder.

As described above, a polyethylene resin-coated paper in which both sides of the base paper were coated with polyethylene (water-impermeable substrate) was obtained.

Preparation of Coating Liquid for Forming Solvent Absorbing Layer

(1) kaolin, (2) ion exchange water, and (3) SHALLOL DC-902P represented by the following composition were mixed and dispersed using a liquid-liquid collision dispersing machine (ULTIMAIZER, trade name, manufactured by Sugino Corporation), and then (4) a polyvinyl alcohol solution, (5) an aqueous surfactant solution and (6) an aqueous cellulose solution were added to the obtained dispersion liquid, and further (7) ion exchange water was used to adjust a density, thereby preparing a coating liquid for forming a solvent absorbing layer.

Composition of coating liquid for forming solvent absorbing layer

(1) Kaolin (KAOCAL, trade name, manufactured by SHIRAISHI CALCIUM KAISHA, LTD., white pigment) 40 parts
(2) Ion exchange water 59.6 parts
(3) SHALLOL DC-902P (51.5% aqueous solution) 0.4 parts
(trade name, manufactured by Dai-ichi Kogyo Seiyaku Co., Ltd., Dispersant, nitrogen-containing organic cationic polymer)
(4) 7% solution of polyvinyl alcohol (JM33, trade name, manufactured by Japan Vam & Poval Co., Ltd.; saponification degree: 95.5%, polymerization degree: 3,300) 41.4 parts
(5) 10% aqueous solution of surfactant (EMULGEN 109P, trade name, manufactured by Kao Corporation) 0.6 parts
(6) 5% solution of cellulose (UCARE OILYMER JR-400, trade name, manufactured by The Dow-chemical Company) 28.6 parts
(7) Ion exchange water 115.1 parts

Preparation of Coating Liquid for Forming Ink Receiving Layer

(1) Gas phase silica fine-particles, (2) ion exchange water, (3) SHALLOL DC-902P (trade name)”, and (4) ZIRCOZOLE ZA-30 represented by the following composition were mixed and were dispersed using a liquid-liquid collision dispersing machine (ULTIMAIZER, trade name, manufactured by Sugino Corporation), and the obtained dispersion liquid was heated to 45° C. and maintained at this temperature for 20 hours. After that, (5) boric acid aqueous solution, and (6) polyvinyl alcohol solution were added at 30° C. to the dispersion liquid to prepare a coating liquid for forming an ink receiving layer.

The content ratio of the gas phase silica fine particles to the polyvinyl alcohol (the water-soluble resin (mass ratio) (PB ratio=(1) gas phase silica fine particles: (6) PVA amount in solution) was 4.9:1. The pH of the coating liquid was 3.4, and the coating liquid indicated acidity.

Composition of Coating Liquid for Forming Ink Receiving Layer

(1) Gas phase silica fine particles (inorganic fine particles) 8.9 parts
(AEROSIL300SF75, trade name, manufactured by NIPPON AEROSIL CO., LTD)
(2) Ion exchange water 47.3 parts
(3) SHALLOL DC-902P (51.5% aqueous solution) 0.8 parts
(trade name, manufactured by Dai-ichi Kogyo Seiyaku Co., Ltd., dispersant, nitrogen-containing organic cationic polymer,)
(4) ZA-30 (trade name, manufactured by Daichi Kigenso Kagaku Kogyo Co., Ltd., zirconyl chloride) 0.5 parts
(5) Boric acid (5% aqueous solution) 6.6 parts
(6) Polyvinyl alcohol (water-soluble resin) solution 26.0 parts

### Composition of Polyvinyl Alcohol Solution

JM33 (trade name) (polyvinyl alcohol (PVA); saponification degree: 95.5%, polymerization degree: 3,300, manufactured by Japan Vam & Poval Co., Ltd.) 1.81 parts
HPC-SS1 (trade name, manufactured by Nippon Soda Co., Ltd., water-soluble cellulose) 0.08 parts
Ion exchange water 23.5 parts
Diethyleneglycol monobutyl ether (BUTYCENOL 20P (trade name), manufactured by Kyowa Hakko Kogyo Co., Ltd.) 0.55 parts
Polyoxyethylene laurylether (surfactant) 0.06 parts
   (EMULGEN 109P (trade name), manufactured by Kao Corporation)

Formation of Solvent Absorbing Layer and Ink Receiving Layer

After corona discharge treatment was carried out on a front face of the obtained water-impermeable substrate, each of the above-described coating liquid for forming a solvent absorbing layer and the above-described coating liquid for forming an ink receiving layer was in-line blended with the following in-line liquid and the blended liquids were coated on the front face in this order from the substrate side with an extrusion die coater to form a two-layer structure by a simultaneous multilayer-coating in a manner such that the coating amount of the coating liquid for forming a solvent absorbing layer was 84.0 g/m² and the coating amount of the coating liquid for forming an ink receiving layer was 58.0 g/m², and the rate of the in-line liquid was 12 g/m². Herein, in the two-layer structure (configuration), the coating liquid for forming a solvent absorbing layer forms a lower layer and the coating liquid for forming an ink receiving layer forms an upper layer, respectively.

Composition of in-Line Liquid
(1) ALFINE 83 (trade name, manufactured by Taimei Chemical Co., Ltd) 2.0 parts
(2) Ion exchange water 8.0 parts

The two-layered coating layer formed by coating of the coating liquid for forming a solvent absorbing layer and the coating liquid for forming an ink receiving layer was dried by a hot-air drier at 80° C. (air speed: from 3 to 8 m/s) in a manner such that the solid content (concentration) of the upper coating layer formed of the coating liquid for forming an ink receiving layer was 36%. The coating layer showed constant rate drying during this period. Immediately after drying (while constant rate drying was shown), the coating layer was immersed in a basic solution having the following composition for 3 seconds and 13 g/m² of the basic solution was deposited on the coating layer, followed by drying at 72° C. for 10 minutes.

Thus, an ink jet recording medium having a solvent absorbing layer (lower layer) and an ink receiving layer (upper layer) in this order from the side of a substrate thereof was prepared.

Composition of Basic Solution

(1) Boric acid 0.65 parts
(2) Ammonium carbonate (first grade: manufactured by Kanto Chemical Co., Inc.) 5.0 parts
(3) Ion exchange water 93.75 parts
(4) Polyoxyethylene lauryl ether (surfactant) 0.6 parts
(EMULGEN 109P, trade name, manufactured by Kao Corporation)

Evaluations

### (1) Glossiness

A 60° glossiness (unit:%) of a surface of the ink receiving layer of the inkjet recording medium obtained above was measured by using a digital variable angle glossmeter manufactured by Suga Test Instruments Co., Ltd. and evaluated in accordance with the following criteria. The result of the evaluation is shown in the following Table 1.

### Evaluation Criteria

AA: 35% or more (Super Excellent)
A: 30% or more but less than 35% (Excellent)
B: 25% or more but less than 30% (Good)
C: 20% or more but less than 25% (Acceptable)
D: Less than 25% (Unacceptable)
(2) Ink absorbency

Solid images were printed using an inkjet printer PIXUS iP4200 (trade name, manufactured by Cannon Inc.) in a variety of square patterns, each square being formed with any one of black, cyan, magenta, yellow, red, green, and blue ink, and these squares being adjacent to each other. A degree of color bleeding at each of the boundary portions of these squares was visually observed whereby the degree of bleeding was used as an index of evaluating of ink absorbency. Herein, BCI-7Bk, BCI-7C, BCI-7M, BCI-7Y, and BCI-3eBk (all trade names, manufactured by Cannon Inc.) were used as an ink cartridge.

### Evaluation Criteria

A: Favorable such that no bleeding is found at boundary portions.
B: Almost no problems, although a little bleeding is found at boundary portions.
C: Practically acceptable, although a certain extent of bleeding is found at boundary portions.
D: Practically intolerable such that bleeding is distinctly found at boundary portions.

### Examples 2 to 9

Inkjet recording mediums of Examples 2 to 9, each having a solvent absorbing layer and an ink receiving layer in this order from the substrate side, were prepared and evaluated in the same manner as the inkjet recording medium of Example 1, except that aqueous solutions of cellulose compounds having a specific concentration thereof as shown in Table 1 were respectively used in place of the aqueous solution containing 5% by mass of JR-400 (cationized HEC) employed as a cellulose compound in the solvent absorbing layer.

### Examples 10 to 13

Inkjet recording mediums of Examples 10 to 13, each having a solvent absorbing layer and an ink receiving layer in this order from the substrate side, were prepared and evaluated in the same manner as the inkjet recording medium of Example 1, except that compositions were changed as shown in Table 1.

### Examples 14 and 14

Inkjet recording mediums of Examples 14 and 15, each having a solvent absorbing layer and an ink receiving layer in this order from the substrate side, were prepared and evaluated in the same manner as the inkjet recording medium of Example 1, except that the content ratio of the cellulose compound to the binder was changed as shown in Table 1.

### Comparative Examples 1 and 2

Inkjet recording mediums of Comparative examples 1 and 2, each having a solvent absorbing layer and an ink receiving layer in this order from the substrate side, were prepared and evaluated in the same manner as the inkjet recording medium of Example 1, except that the kind of the pigment was changed or not changed and none of cellulose compound was incorporated in the solvent absorbing layer.

TABLE 1

| | Solvent absorbing layer | | | | | | | | |
|---|---|---|---|---|---|---|---|---|---|
| | | Cellulose compound | | | | | | | |
| | | | | | Concentration | Content with | | | |
| | Kind | | | | in Aqueous | respect to | Ratio of | Evaluation | |
| | of | | | Cationization | Solution (% by | Application | Cellulose/ | Glossiness | Ink |
| | Pigment | Name | Kind | degree (%) | mass) | liquid (%) | Binder | (60° C.) | absorbency |
| Example 1 | KAOCAL | JR-400 | Cationized HEC | 2.0 | 5 | 0.5 | 0.49 | AA | A |
| Example 2 | KAOCAL | QH-200 | Cationized HEC | 1.7 | 5 | 0.5 | 0.49 | AA | A |
| Example 3 | KAOCAL | LR-400 | Cationized HEC | 1.0 | 5 | 0.5 | 0.49 | A | A |
| Example 4 | KAOCAL | LK | Cationized HEC | 0.5 | 5 | 0.5 | 0.49 | B | A |
| Example 5 | KAOCAL | HPC-M | HPC | 0.0 | 5 | 0.5 | 0.49 | C | B |
| Example 6 | KAOCAL | SM-400 | MC | 0.0 | 5 | 0.5 | 0.49 | C | B |
| Example 7 | KAOCAL | POIZ | Cationized HEC | 1.3 | 1 | 0.1 | 0.10 | A | B |
| | | C-150L | | | | | | | |
| Example 8 | KAOCAL | HPC-H | HPC | 0.0 | 2 | 0.2 | 0.20 | C | C |
| Example 9 | KAOCAL | SM-1500 | MC | 0.0 | 2 | 0.2 | 0.20 | C | C |
| Example 10 | CALLITE SA | HPC-H | HPC | 0.0 | 2 | 0.2 | 0.20 | C | C |
| Example 11 | KAOBRITE | JR-400 | Cationized HEC | 2.0 | 5 | 0.5 | 0.49 | A | C |
| Example 12 | KAOCAL | QH-200 | Cationized HEC | 1.7 | 5 | 1.0 | 0.99 | A | A |
| Example 13 | KAOCAL | JR-400 | Cationized HEC | 2.0 | 5 | 0.2 | 0.20 | B | A |
| Example 14 | KAOCAL | JR-400 | Cationized HEC | 2.0 | 5 | 0.05 | 0.05 | C | C |
| Example 15 | KAOCAL | JR-400 | Cationized HEC | 2.0 | 5 | 0.02 | 0.02 | C | C |
| Comparative | KAOCAL | — | — | — | — | — | 0.49 | D | D |
| example 1 | | | | | | | | | |
| Comparative | CALLITE SA | — | — | — | — | — | 0.49 | D | D |
| example 2 | | | | | | | | | |

Details of components shown in Table 1 are shown below.

### Pigment

CALLITE SA: trade name, calcium carbonate (average diameter: 3.3 μm) manufactured by Shiraishi Kogyo Kaisha, Ltd.

KAOBRITE: trade name, kaolin clay (average diameter: 1.8 μm) manufactured by Shiraishi Calcium Kaisha, Ltd.

### Cationic Cellulose

JR-400: UCARE POLYMER JR-400 (trade name, cationized hydroxyethyl cellulose, manufactured by Dow Chemical Company)

LR-400: UCARE POLYMER LR-400 (trade name, cationized hydroxyethyl cellulose, manufactured by Dow Chemical Company)

LK: UCARE POLYMER LK (trade name, cationized hydroxyethyl cellulose, manufactured by Dow Chemical Company)

QH-200: JELLNER QH-200 (trade name, cationized hydroxyethyl cellulose, manufactured by Daicel Chemical Industries, Ltd.)

C-150L: POIZ C-150L (trade name, cationized hydroxyethyl cellulose, manufactured by Kao Corporation)

### Nonionic Cellulose

HPC-M and HPC-H: both trade names, hydroxypropyl cellulose, manufactured by Nippon Soda Co., Ltd.

SM-400 and SM-1500: both trade names, methyl cellulose, manufactured by Shin-Etsu Chemical Co., Ltd.

As shown in Table 1, Examples exhibited favorable ink absorbency and excellent glossiness comparing to Comparative examples. Specifically, remarkable improvements were observed when cationic cellulose compounds were used. In contrast, Comparative examples exhibited poor ink absorbency and insufficient glossiness.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording medium comprising:
a substrate;
a solvent absorbing layer, provided on the substrate, comprising a white pigment other than silica particles, a binder, and a cationic or nonionic cellulose compound; and
an ink receiving layer, provided on the solvent absorbing layer, comprising inorganic fine particles and a water-soluble resin.

2. The inkjet recording medium according to claim 1, wherein a content ratio of the cellulose compound to the binder (the cellulose/the binder) in the solvent absorbing layer is from 1/15 to 3/1.

3. The inkjet recording medium according to claim 1, wherein the cationic or nonionic cellulose compound comprises a cationized hydroxyethyl cellulose, a hydroxypropyl cellulose, or a methyl cellulose.

4. The inkjet recording medium according to claim 1, wherein the binder in the solvent absorbing layer is a water-soluble resin or a latex resin.

5. The inkjet recording medium according to claim 1, wherein at least one of the solvent absorbing layer or the ink receiving layer comprises a nitrogen-containing organic cationic polymer.

6. The inkjet recording medium according to claim 1, wherein the inorganic fine particles in the ink receiving layer comprise gas phase silica.

7. The inkjet recording medium according to claim 1, wherein the water-soluble resin comprises a polyvinyl alcohol.

8. The inkjet recording medium according to claim 1, wherein a cationization degree of the cationic cellulose compound is 0.8% or more.

9. The inkjet recording medium according to claim 1, wherein the white pigment comprises at least one of kaolin or calcium carbonate.

10. The inkjet recording medium according to claim 1, wherein the ink receiving layer comprises a boron compound.

11. The inkjet recording medium according to claim 1, wherein the ink receiving layer comprises a zirconium compound.

12. The inkjet recording medium according to claim 1, wherein the ink receiving layer comprises a water-soluble aluminum compound.

13. The inkjet recording medium according to claim 1, wherein the substrate is water-impermeable.

14. An image forming method comprising:
applying an ink, by ink-jetting, onto the inkjet recording medium according to claim 1, to form an image,
wherein a coating liquid of the solvent absorbing layer and a coating liquid of the ink receiving layer are provided in this order from the substrate side of the inkjet recording medium; and
drying the formed image by heating.

15. The image forming method according to claim 14, the method comprising:
applying, onto a coating layer, a basic solution containing a basic compound either (1) at the same time as forming the coating layer by coating at least the coating liquid for the ink receiving layer on the coating liquid of the solvent absorbing layer, or (2) during drying of the coating layer, but before a decrease in drying rate of the coating layer.
